(19) United States
(12) Patent Application Publication
(10) Pub. No.: US 2025/0111319 A1
(43) Pub. Date: Apr. 3, 2025

(54) SYSTEMS AND METHODS FOR MANAGING HYDROCARBON SITES

(71) Applicant: Sensia Netherlands B.V., Rotterdam (NL)

(72) Inventors: Yasser El-Khazindar, London (GB); Anissa Shenelle Thomas, Sangre Chiquito (TT); John Allen Wilkins, JR., Broken Arrow, OK (US)

(21) Appl. No.: 18/900,322

(22) Filed: Sep. 27, 2024

Related U.S. Application Data
(60) Provisional application No. 63/541,618, filed on Sep. 29, 2023.

(51) Int. Cl. G06Q 10/0637; G06Q 50/02

(52) U.S. Cl. CPC G06Q 10/0637; G06Q 50/02

(57) ABSTRACT

A method for managing a well site includes acquiring, from a sensing unit associated with the well site, sensor data associated with operation of the well site, determining, based on the sensor data, at least one of emission data corresponding to emissions associated with the well site or resource usage data corresponding to resource usage associated with the well site, generating display data corresponding to the at least one of the emission data or the resource usage data, and operating a display device to provide the display data to a user

### CROSS-REFERENCE TO RELATED PATENT APPLICATION

This application claims the benefit of and priority to U.S. Provisional Patent Application No. 63/541,618, filed Sep. 29, 2023, the entire disclosure of which is incorporated by reference herein.

### BACKGROUND

The present disclosure relates to hydrocarbon sites. More specifically, the present disclosure relates to control systems for hydrocarbon sites including but not limited to control systems using measurements to calculate energy parameters associated with industrial devices and compare the energy parameters to predetermined Key Performance Indicators (KPIs) in industrial systems, such as gas, geothermal, helium, and oil well sites.

### SUMMARY

One implementation of the present disclosure relates to a method for managing a well site. The method includes acquiring, from a sensing unit associated with the well site, sensor data associated with operation of the well site, determining, based on the sensor data, at least one of emission data corresponding to emissions associated with the well site or resource usage data corresponding to resource usage associated with the well site, generating display data corresponding to the at least one of the emission data or the resource usage data, and operating a display device to provide the display data to a user.

Another implementation of the present disclosure relates to a computing system configured to monitor and/or control one or more operations of a hydrocarbon site. The computing system includes a processor. The processor is configured to acquire, from a sensing unit associated with the hydrocarbon site, sensor data associated with operation of the hydrocarbon site, determine, based on the sensor data, at least one of emission data corresponding to emissions associated with the hydrocarbon site or resource usage data corresponding to resource usage associated with the hydrocarbon site, determine, based on the sensor data, a portion of the of the at least one of the emission data or the resource usage data associated with operation of an artificial lift system of the hydrocarbon site, generate display data corresponding to the portion of the at least one of the emission data or the resource usage data, and operate a display device to provide the display data to a user.

Yet another implementation of the present disclosure relates to a hydrocarbon site. The hydrocarbon site includes a first site device, a second site device, and a processor. The processor is configured to acquire, from a sensing unit associated with the hydrocarbon system, sensor data associated with operation of the first site device and the second site device, determine, based on the sensor data, at least one of (i) first emission data associated with operation of the first site device and second emission data associated with the second site device or (ii) first resource usage data associated with the operation of the first site device and second resource usage data associated with the operation of the second site device, generate display data corresponding to the at least one of (i) the first emission data and the second emission data or (ii) the first resource usage data and the second resource usage data, and operate a display device to provide the display data to a user.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 illustrates a block diagram of a high-level overview of an industrial enterprise including a cloud-based computing system, according to some embodiments;

FIG. 2 illustrates a schematic diagram of an example hydrocarbon site that may produce and process hydrocarbons, according to some embodiments;

FIG. 3 illustrates an example overview of a cloud-based communication architecture for the example hydrocarbon site of FIG. 2 including an artificial lift system (ALS), according to some embodiments;

FIGS. 4A & 4B illustrates a block diagram of a system for determining emissions and/or an emission intensity associated with a well site or multiple well sites, according to some embodiments;

FIG. 5 illustrates a block diagram of a system for determining a resource usage and/or a resource intensity associated with a well site or multiple well sites, according to some embodiments;

FIG. 6 illustrates a flow diagram of a process for operating a well site or multiple well sites using the system of FIG. 4 and/or the system of FIG. 5, according to some embodiments;

FIG. 7 illustrates a block diagram of a controller configured to perform an optimization for a well site or multiple well sites, according to some embodiments;

FIG. 8 illustrates a block diagram of a cloud computing system in communication with controllers at multiple well sites, each of the controllers configured to perform an independent optimization, according to some embodiments;

FIG. 9 illustrates a flow diagram of a process for selecting between different optimization schemes for a well site or multiple well sites, according to some embodiments;

FIG. 10 illustrates a flow diagram of a process for optimizing a well site or multiple well sites to minimize resource usage and/or resource intensity of the well site or the multiple well sites, according to some embodiments;

FIG. 11 illustrates a flow diagram of a process for optimizing a well site or multiple well sites to minimize emissions and/or emission intensity of the well site or the multiple well sites, according to some embodiments; and

FIG. 12 illustrates a flow diagram of a process for optimizing a well site or multiple well sites to maximize production of the well site or the multiple well sites, according to some embodiments.

FIG. 13 illustrates an example user interface that may be provided to a display device by the controller of FIG. 7, according to some embodiments.

### DETAILED DESCRIPTION

Before turning to the FIGURES, which illustrate certain exemplary embodiments in detail, it should be understood that the present disclosure is not limited to the details or methodology set forth in the description or illustrated in the FIGURES. It should also be understood that the terminology used herein is for the purpose of description only and should not be regarded as limiting.

### Overview

Referring generally to the FIGURES, systems and methods for optimization of a well site are shown, according to some embodiments. In some embodiments, the well site includes an artificial lift system that includes pumps or compressors for producing a product from a hydrocarbon site, according to some embodiments. The artificial lift system may include an electrical submersible pump, a gas lift, a reciprocating pump, or a progressive cavity pump. In some embodiments, a controller is configured to use system information of the well site or multiple of the well sites and equipment of the well site or multiple of the well sites, utility costs, mathematical models of the different equipment of the well site or multiple of the well sites, sensor data from the well site or multiple of the well sites, etc. to determine a resource usage, a resource intensity, emissions (e.g., a carbon footprint, carbon emissions, etc.), and/or a emission intensity (e.g., a carbon emission intensity, etc.) associated with the well site or multiple of the well sites. The controller may display the resource usage, the resource intensity, the emissions, and/or the emission intensity associated with the well site or the multiple of the well sites on a display device such that an operator of the well site or the multiple of the well sites may visualize the resource usage, the resource intensity, the emissions, and/or the emission intensity. In some embodiments, the controller is configured to compare the resource usage, the resource intensity, the emissions, and/or the emission intensity to predetermined values (e.g., a predetermined threshold, a predetermined objective, a predetermined KPI, etc.) and display the difference between the resource usage, the resource intensity, the emissions, and/or the emission intensity and the predetermined value on the display device for a user. The predetermined value may be a standard (e.g., from a governing agency, etc.), a customer objective, and/or based on other operational factors. In some embodiments, the predetermined value may be adjusted over time based on changes to the standards, changes to the customer objectives, changes to the other operational factors, and/or based on the value of the resource usage, the resource intensity, the emissions, and/or the emission intensity. In some embodiments, the predetermined value may be adjusted based on historical data of the resource usage, the resource intensity, the emissions, and/or the emission intensity (e.g., trends in the historical data, using historical data to predict future results, etc.).

In some embodiments, the controller is configured to compare the resource usage, the resource intensity, the emissions, and/or the emission intensity associated with multiple of the well devices of the well site and/or multiple of the well devices of the multiple of the well sites and display the comparison between the results on the display device for the user. For example, the controller may determine a first resource usage, a first resource intensity, a first emissions, and/or a first emission intensity associated with a first well device and a second resource usage, a second resource intensity, a second emissions, and/or a second emission intensity associated with a second well device and display the results on the user device. As a result, an operator of the first well device and the second well device may compare the resource usage and the emissions associated with the first well device and the second well device to determine how to change operation of the first well device and/or the second well device to reduce combined emissions and/or combined resource usage of the first well device and the second well device.

In some embodiments, the controller is configured to use system information of the well site or multiple of the well sites and equipment of the well site or multiple of the well sites, utility costs, mathematical models of the different equipment of the well site or multiple of the well sites, sensor data from the well site or multiple of the well sites, a mode of optimization, etc., to define an objective function. The objective function may define resource usage, resource intensity, emissions, emission intensity, and/or production in terms of one or more decision variables for a future time horizon. In some embodiments, the one or more decision variables are for a future time horizon related to a function of the artificial lift system. An optimization may be performed to minimize or maximize the objective function to determine optimal control decisions to minimize resource usage, minimize resource intensity, minimize emissions, minimize emissions intensity, or maximize throughput. The controller may operate the display device to display the optimal control decisions to an operator of the well site such that the operator may operate the well site according to the optimal control decisions.

In some embodiments, the control decisions are output to the well site or multiple of the well sites for use in operating the well site or multiple of the well sites. For example, the control decisions may be output to the well site automatically or upon receiving a user input from the operator of the well site. In some embodiments, the control decisions are output to the artificial lift system of the well site or artificial lift systems of multiple of the well sites for use in operating the artificial lift system of the well site or artificial lift systems of multiple of the well sites. For the optimization of multiple of the well sites, the optimization can be performed locally at each well site to optimize the operation of each well site, or can be performed globally (e.g., by a cloud computing system, etc.) to optimize the combination of multiple of the well sites.

System Overview Cloud-Based Computing System

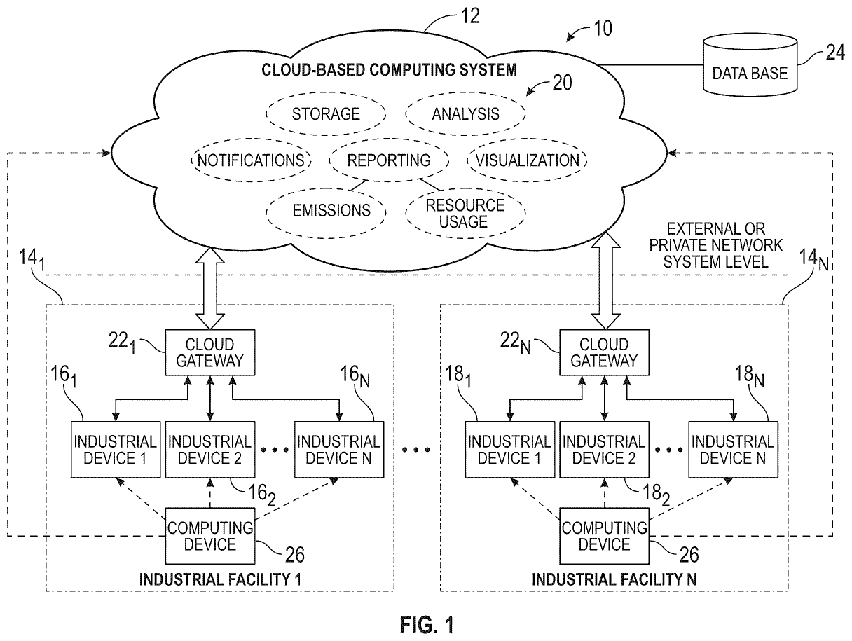

By way of introduction, FIG. 1 illustrates a high-level overview of an industrial enterprise such as a hydrocarbon site 10 that leverages a cloud-based computing system to improve the operations of various industrial devices. The enterprise or hydrocarbon site 10 may include one or more industrial facilities 14, each having a number of industrial devices 16 and 18 in use. The industrial devices 16 and 18 may make up one or more automation systems operating within the respective facilities 14. Exemplary automation systems may include, but are not limited to, batch control systems (e.g., mixing systems), continuous control systems (e.g., proportional-integral-derivative (PID) control systems), or discrete control systems. Industrial devices 16 and 18 may include devices, such as industrial controllers (e.g., programmable logic controllers or other types of programmable automation controllers), field devices such as sensors and meters, motor drives, operator interfaces (e.g., human-machine interfaces, industrial monitors, graphic terminals, message displays, etc.), industrial robots, barcode markers and readers, vision system devices (e.g., vision cameras), smart welders, or other such industrial devices.

In certain embodiments, the industrial devices 16 and 18 may communicatively couple to a computing device 26. The communication link between the industrial devices 16 and 18 and the computing device 26 may be a wired or a wireless connection, such as Wi-Fi®, Bluetooth®, MQTT®, and the like. Generally, the computing device 26 may be any type of processing device that may include communication abilities, processing abilities, and the like. For example, the computing device 26 may be a controller, such as a programmable logic controller (PLC), a programmable automation controller (PAC), or any other controller that may monitor, control, and operate the industrial device 16 and 18. The computing device 26 may be incorporated into any physical device (e.g., the industrial device 16 and 18) or may be implemented as a stand-alone computing device (e.g., general purpose computer), such as a desktop computer, a laptop computer, a tablet computer, a mobile computing device, or the like. Moreover, the communication data to and from the computing device 26 may include various safeguards to ensure privacy and security of the communication link (e.g., by encrypting the communication data, by requiring an authentication of a user before granting access to the communication data, by using a firewall to restrict access to the communication data, etc.)

In addition to communicating with the industrial devices 16 and 18, the computing device 26 may establish a communication link with the cloud-based computing system 12. As such, the computing device 26 may have access to a number of cloud-based services provided by the cloud-based computing system 12, as will be described in more detail below. Generally, the computing device 26 may send and receive data to and from the cloud-based computing system 12 to assist a user of the industrial device 16 or 18 in the commissioning, operation, and maintenance of the industrial automation systems.

Exemplary automation systems can include one or more industrial controllers that facilitate monitoring and control of their respective processes and emissions. The controllers may exchange data with the field devices using native hardwired I/O or via a plant network such as Ethernet/IP, Data Highway Plus, ControlNet, DeviceNet, or the like. A given controller may receive any combination of digital or analog signals from the field devices indicating a current state of the devices, their associated processes, and uncertainty related thereto (e.g., temperature, position, on or off status, fluid level, etc.), and executes a user-defined control program that performs automated decision-making for the controlled processes based on the received signals. The controller may then output appropriate digital and/or analog control signaling to the field devices in accordance with the decisions made by the control program. These outputs may include device actuation signals, temperature or position control signals, operational commands to infield mechanical equipment, infield control signals, motion control signals, and the like. The control program may include any suitable type of code used to process input signals read into the controller and to control output signals generated by the controller, including but not limited to ladder logic, sequential function charts, function block diagrams, structured text, ISaGRAF®, or other such platforms.

Although the industrial enterprise or hydrocarbon site 10 illustrated in FIG. 1 depicts the industrial devices 16 and 18 as residing in fixed-location industrial facilities 14, the industrial devices 16 and 18 may be part of a mobile control application, such as a system contained in a truck or other service vehicle. Additionally, although the industrial enterprise or hydrocarbon site 10 of FIG. 1 is described with respect to hydrocarbon production well sites, it should be noted that the systems and method for the industrial enterprise or hydrocarbon site 10 described herein may be applied to other automation systems.

In certain embodiments, the industrial devices 16 and 18 may be communicatively coupled to the cloud-based computing system 12 that may provide various applications, analysis operations, and access to data that may be unavailable to the industrial devices 16 and 18. The industrial devices can produce measurements and uncertainty values associated with the measurements. In some embodiments, the industrial device 16 and 18 may interact with the cloud-based computing system 12, such that the industrial device 16 and 18 may use various cloud-based services 20 to perform its respective operations more efficiently or effectively. The cloud-based computing system 12 may be any infrastructure that enables the cloud-based services 20 to be accessed and utilized by cloud-capable devices. In one embodiment, the cloud-based computing system 12 may include a number of computers that may be connected through a real-time communication network, such as the Internet, Ethernet/IP, ControlNet, or the like. By employing a number of computers, the cloud-based computing system 12 may distribute large-scale analysis operations over the number of computers that make up the cloud-based computing system 12.

Generally, the computers or computing devices provided by the cloud-based computing system 12 may be dedicated to performing various types of complex and time-consuming analysis that may include analyzing a large amount of data. In some embodiments, the computers or computing devices provided by the cloud-based computing system 12 provide emissions reporting. The emissions reporting may include tracking emissions (e.g., carbon footprint, the amount of greenhouse gases generated over a time period, the amount of carbon dioxide and methane generated over a time period, the amount of emissions generated over a time period converted into a carbon dioxide equivalent, etc.) and energy usage (e.g., the amount of energy consumed over a time period, etc.). In some embodiments, the emissions reporting may include tracking the amount of carbon dioxide, methane, volatile organic compounds (VOCs), nitrogen oxides, sulfur oxides, and/or other emissions generated over a time period. In some embodiments, the emissions reporting can provide production efficiency tracking. In some embodiments, the emissions reporting includes tracking energy usage against consents, chemical usage against constants, vent gas against consents, and emissions against carbon credits along with uncertainty values for each. Reports of mass carbon dioxide and associated uncertainty for streams and totals for stations can be provided as part of the emissions and energy usage reporting. As a result, the industrial device 16 or 18 may continue its respective processing operations without performing additional processing or analysis operations that may involve analyzing large amounts of data collected from other data sources.

In certain embodiments, the cloud-based computing system 12 may be a public cloud accessible via the Internet by devices having Internet connectivity and appropriate authorizations to utilize the cloud-based services 20. In some scenarios, the cloud-based computing system 12 may be a platform-as-a-service (PaaS), and the cloud-based services 20 may reside and execute on the cloud-based computing system 12. In some embodiments, cloud-based computing system—is configured to provide, storage, notifications, reporting, visualization, and analysis of emissions and uncertainty.

### Hydrocarbon Site

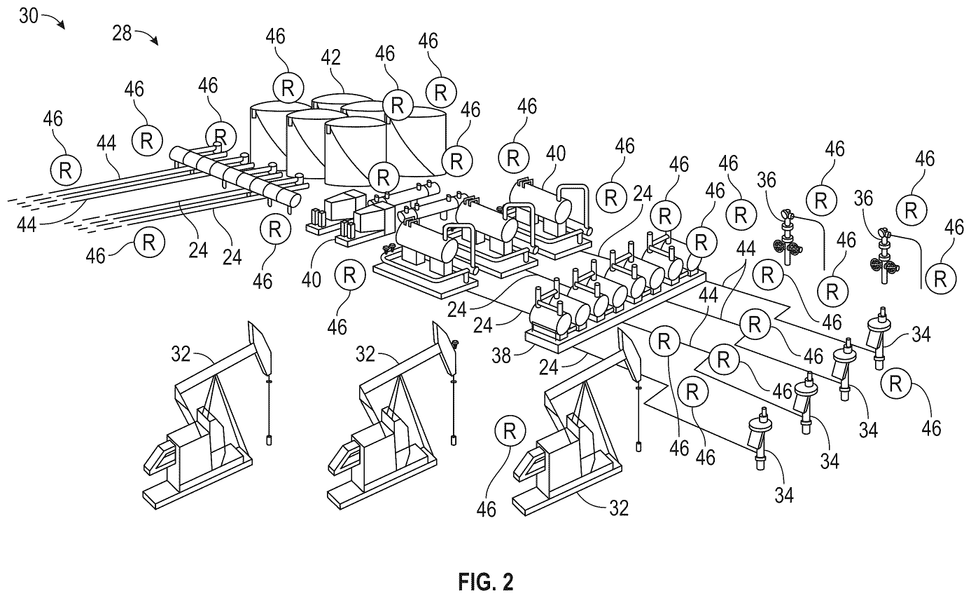

Referring now to FIG. 2, the hydrocarbon site 10 can be embodied as hydrocarbon site 30. Hydrocarbon site 30 is an area in which hydrocarbons, such as crude oil and natural gas, may be extracted from the ground, processed, and stored in some embodiments. As such, the hydrocarbon site 30 may include a number of well sites, shown as well sites 28, and a number of well devices that may control the flow of hydrocarbons being extracted from the well sites 28. In one embodiment, the well devices at the hydrocarbon site 30 may include any device equipped to monitor and/or control production of hydrocarbons at the well sites 28. As such, the well devices may include pumpjacks 32, submersible pumps 34, well trees 36, and the like. After the hydrocarbons are extracted from the surface via the well devices, the extracted hydrocarbons may be distributed to other devices such as wellhead distribution manifolds 38, separators 40, storage tanks 42, and the like. At the hydrocarbon site 30, the pumpjacks 32, submersible pumps 34, well trees 36, wellhead distribution manifolds 38, separators 40, and storage tanks 42 may be connected together via a network of pipelines 44. As such, hydrocarbons extracted from a reservoir may be transported to various locations at the hydrocarbon site 30 via the network of pipelines 44. Conduits used on hydrocarbon site 30 may include flow meters for providing flow measurements and uncertainty values for the flow measurements.

The pumpjack 32 may mechanically lift hydrocarbons (e.g., oil) out of a well when a bottom hole pressure of the well is not sufficient to extract the hydrocarbons to the surface. The submersible pump 34 may be an assembly that may be submerged in a hydrocarbon liquid that may be pumped. As such, the submersible pump 34 may include a hermetically sealed motor, such that liquids may not penetrate the seal into the motor. Further, the hermetically sealed motor may push hydrocarbons from underground areas or the reservoir to the surface.

The well trees 36 or Christmas trees may be an assembly of valves, spools, and fittings used for natural flowing wells. As such, the well trees 36 may be used for an oil well, gas well, water injection well, water disposal well, gas injection well, condensate well, and the like. The wellhead distribution manifolds 38 may collect the hydrocarbons that may have been extracted by the pumpjacks 32, the submersible pumps 34, and the well trees 36, such that the collected hydrocarbons may be routed to various hydrocarbon processing or storage areas in the hydrocarbon site 30.

The separator 40 may include a pressure vessel that may separate well fluids produced from oil and gas wells into separate gas and liquid components. For example, the separator 40 may separate hydrocarbons extracted by the pumpjacks 32, the submersible pumps 34, or the well trees 36 into oil components, gas components, and water components. After the hydrocarbons have been separated, each separated component may be stored in a particular storage tank 42. The hydrocarbons stored in the storage tanks 42 may be transported via the pipelines 44 to transport vehicles, refineries, and the like. The well devices may include flaring and venting mechanisms such as systems for flaring and venting natural gas sources.

The well devices may include monitoring systems that may be placed at various locations in the hydrocarbon site 30 to monitor or provide information related to certain aspects of the hydrocarbon site 30. As such, the monitoring system may be a flow meter, temperature sensor, pressure sensor, composition analyzer, density analyzer, controller, a remote terminal unit (RTU), any computing device that may include communication abilities, processing abilities, sensor and the like. For discussion purposes, the monitoring system will be embodied as the RTU 46 throughout the present disclosure. However, it should be understood that the RTU 46 may be any component capable of monitoring and/or controlling various components at the hydrocarbon site 30.

The RTU 46 may include sensors or may be coupled to various sensors that may monitor various properties associated with a component at the hydrocarbon site 10. The RTU 46 may then analyze the various properties associated with the component and may control various operational parameters of the component. In some embodiments, the RTU 46 may include sensors or be coupled to various sensors that are temporarily associated with a component at the hydrocarbon site 10 (e.g., a drone inspecting the hydrocarbon site 30, a portable sensor used to inspect the hydrocarbon site 30, etc.). For example, the RTU 46 may measure a pressure or a differential pressure of a well or a component (e.g., storage tank 42) in the hydrocarbon site 30.

The RTU 46 may measure a temperature of contents stored inside a component in the hydrocarbon site 30, an amount of hydrocarbons being processed or extracted by components in the hydrocarbon site 30, and the like. The RTU 46 may measure a level or amount of hydrocarbons stored in a component, such as the storage tank 42. In certain embodiments, the RTU 46 may be iSens-GP Pressure Transmitter, iSens-DP Differential Pressure Transmitter, iSens-MV Multivariable Transmitter, iSens-T2 Temperature Transmitter, iSens-L Level Transmitter, or Isens-IO Flexible I/O Transmitter manufactured by Sensia LLC® of Houston, Texas.

In one embodiment, the RTU 46 may include a sensor that may measure pressure, temperature, fill level, flow rates, and the like. The RTU 46 may include a transmitter, such as a radio wave transmitter, that may transmit data acquired by the sensor via an antenna or the like. The sensor in the RTU 46 may be wireless sensors that may be capable of receiving and sending data signals between computing device 26 (e.g., RTUs). To power the sensors and the transmitters, the RTU 46 may include a battery or may be coupled to a continuous power supply. Since the RTU 46 may be installed in harsh outdoor and/or explosion-hazardous environments, the RTU 46 may be enclosed in an explosion-proof container that may meet certain standards established by the National Electrical Manufacturer Association (NEMA) and the like, such as a NEMA 4X container, a NEMA 7X container, and the like.

The RTU 46 may transmit data acquired by the sensor or data processed by a processor to other monitoring systems, a router device, a supervisory control and data acquisition (SCADA) device, or the like. As such, the RTU 46 may enable users to monitor various properties of various components in the hydrocarbon site 30 without being physically located near the corresponding components.

In operation, the RTU 46 may receive real-time or near real-time data associated with a well device. The data may include, for example, tubing head pressure, tubing head temperature, case head pressure, flowline pressure, wellhead pressure, wellhead temperature and the like. In any case, the RTU 46 may analyze the real-time data with respect to static data that may be stored in a memory of the RTU 46. The static data may include a well depth, a tubing length, a tubing size, a choke size, a reservoir pressure, a bottom hole temperature, well test data, fluid properties of the hydrocarbons being extracted, and the like. The RTU 46 may analyze the real-time data with respect to other data acquired by various types of instruments (e.g., water cut meter, multiphase meter) to determine an inflow performance relationship (IPR) curve, a desired operating point for the wellhead or hydrocarbon site 30, key performance indicators (KPIs) associated with the wellhead or hydrocarbon site 30, wellhead performance summary reports, and the like. Although the RTU 46 may be capable of performing the above-referenced analyses, in some cases the RTU 46 may not be capable of performing the analyses in a timely manner due to the intensity of the above-referenced analyses and the limited processing power of the RTU 46.

In some embodiments, the RTU 46 may establish a communication link with the cloud-based computing system 12 described above. As such, the cloud-based computing system 12 may use its larger processing capabilities to analyze data acquired by multiple of the computing devices 26 (e.g., RTUs). Moreover, the cloud-based computing system 12 may access historical data associated with the respective RTU 46, data associated with well devices associated with the respective RTU 46, data associated with the hydrocarbon site 30 associated with the respective RTU 46 and the like to further analyze the data acquired by the RTU 46.

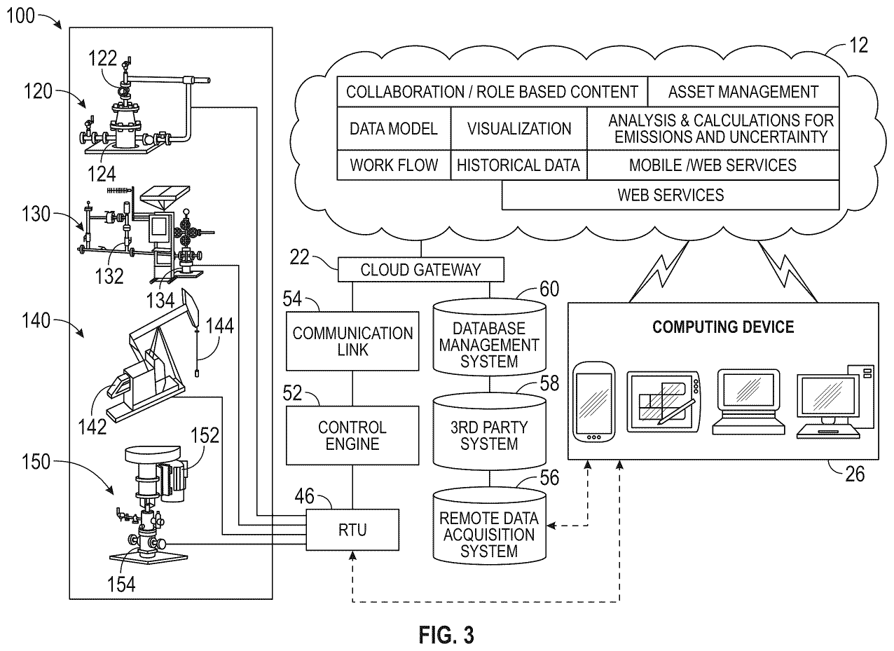

Accordingly, in one embodiment, the RTU 46 may communicatively couple to the cloud-based computing system 12 via a cloud-based communication architecture or services 20 as shown in FIG. 3. Referring to FIG. 3, the RTU 46 may communicatively couple to a control engine 52 such as ControlLogix® or the like. The control engine 52 may, in turn, communicatively couple to a communication link 54 that may provide a protocol or specifications such as OPC Data Access that may enable the control engine 52 and the RTU 46 to continuously communicate its data to the cloud-based computing system 12 or computing device 26. The communication link 54 may be communicatively coupled to the cloud gateway 22, which may then provide the control engine 52 and the RTU 46 access to communicate with the cloud-based computing system 12. Although the RTU 46 is described as communicating with the cloud-based computing system 12 via the control engine 52 and the communication link 54, it should be noted that in some embodiments, the RTU 46 may communicate directly with the cloud gateway 22 like the industrial device 16 and 18 of FIG. 1 or may communicate directly with the cloud-based computing system 12.

In some embodiments, the computing device 26 (e.g., RTU) may communicatively couple to the control engine 52 or the communication link 54 via an Ethernet IP/Modbus network. As such, a polling engine may connect to the computing device 26 (e.g., RTU) via the Ethernet IP/Modbus network to poll the data acquired by the computing device 26 (e.g., RTU). The polling engine may then use an Ethernet network to connect to the cloud-based computing system 12.

As mentioned above, the RTU 46 may monitor and control various types of well devices and may send the data acquired by the respective well devices to the cloud-based computing system 12 according to the architecture described above. For example, as shown in FIG. 3, the RTU 46 may monitor and control an artificial lift system (ALS) 100 of the well sites 28 in cases where the bottom hole pressure of the well sites 28 is not sufficient to extract the hydrocarbons to the surface at an acceptable rate. The ALS 100 can utilize an electrical submersible pump (ESP) 120, a gas lift (GL) 130, a rod pump controller (RPC) 140, a progressive cavity pump (PCP) 150, and the like. The ALS 100 includes one or more controllable elements (e.g., a pump, a compressor, a valve, etc.).

Regarding the ESP 120, the RTU 46 may receive sensor data corresponding to the ESP 120 and/or may control operating variables related to the ESP 120. For example, the RTU 46 may obtain sensor data corresponding to an ESP motor 122 driving an ESP pump 124 in the ESP 120 and/or may provide control signals to the ESP motor 122 driving the ESP pump 124 to increase or decrease movement of fluid to the surface (e.g., a flow rate of the fluid to the surface, a pressure of the fluid, etc.) outputted by the ESP 120. In some embodiments, the RTU 46 provides control signals associated with controlling an amount of power that is provided to the ESP motor 122. The power provided to the ESP motor 122 may be provided by a generator, a utility connection, and/or a different source (e.g., diesel when the ESP motor 122 is a diesel motor, etc.). The RTU 46 may obtain sensor data (e.g., ALS data, lift data, etc.) corresponding to electrical signals (e.g., control signals, etc.) provided to the ESP 120, the power provided to the ESP motor 122, an input pressure of the hydrocarbons received by (e.g., inputted into, etc.) the ESP 120, an outlet pressure of the hydrocarbons exiting the ESP 120, and/or a temperature of the hydrocarbons provided by (e.g., outputted by, etc.) the ESP 120.

Regarding the GL 130, the RTU 46 may receive sensor data corresponding to the GL 130 and/or may control operating variables related to the GL 130 (e.g., a gas lift injection flow to operator flow rate, real-time estimated gas-oil-water production, etc.). For example, the RTU 46 may obtain sensor data corresponding to a GL manifold 132 and/or may provide control signals to the GL manifold 132 to control a flow of gas (e.g., air, natural gas, etc.) that is provided to the hydrocarbons in order to increase movement of the fluid to the surface by decreasing the density of the hydrocarbons. In some embodiments, the RTU 46 provides controls signals associated with controlling an amount of power that is provided to the GL manifold 132 and/or a GL compressor 134 configured to pressurize the gas that is provided to the hydrocarbons. The power provided to the GL 130 may be provided by a generator, a utility connection, and/or a different source (e.g., diesel when the GL compressor 134 is a diesel compressor, etc.). The RTU 46 may obtain sensor data corresponding to electrical signals (e.g., control signals, etc.) provided to the GL 130, the power provided to the GL compressor 134, an input pressure of the hydrocarbons below the GL 130, an outlet pressure of the hydrocarbons above the GL 130, a flow rate of the gas flowing through the GL manifold 132, a flow rate of the gas outputted by the GL compressor, and/or a temperature of the hydrocarbons flowing through the GL 130.

Regarding the RPC 140, the RTU 46 may receive sensor data corresponding to the RPC 140 and/or may control operating variables related to the RPC 140. For example, the RTU 46 may obtain sensor data corresponding to an RPC motor 142 configured to drive a rod pump 144 to increase or decrease movement of fluid to the surface and/or may provide control signals to the RPC motor 142 to control the movement of fluid to the surface. In some embodiments, the RTU 46 provides control signals associated with controlling an amount of power that is provided to the RPC motor 142. The power provided to the RPC motor 142 may be provided by a generator, a utility connection, and/or a different source (e.g., diesel when the RPC motor 142 is a diesel motor, etc.). The RTU 46 may obtain sensor data corresponding to electrical signal (e.g., control signals, etc.) provided to the RPC 140, the power provided to the RPC motor 142, an inlet pressure of the hydrocarbons below the rod pump 144, an outlet pressure of the hydrocarbons above the rod pump 144, and/or a temperature of the hydrocarbons flowing through the RPC 140. In some embodiments, the RTU 46 may receive sensor data corresponding to polish rod loads and continuous walking beam positions associated with the rod pump 144 and may develop dynamometer cards corresponding to the rod pump 144.

Regarding the PCP 150, the RTU 46 may receive sensor data corresponding to the PCP 150 and/or may control operating variables related to the PCP 150. For example, the RTU 46 may obtain sensor data corresponding to a PCP motor 152 configured to drive a helical rotor 154 to increase or decrease movement of fluid to the surface and/or may provide control signals to the PCP motor 152 to control the movement of the fluid to the surface. In some embodiments, the RTU 46 performs basic analysis on the operation of the PCP 150 based on the sensor data and provides control signals to the PCP 150 to change pumping conditions of the PCP 150 based on the sensor data received from the PCP 150. In some embodiments, the RTU 46 provides control signals associated with controlling an amount of power that is provided to the PCP 150. The power provided to the PCP 150 may be provided by a generator, a utility connection, and/or a different source (e.g., diesel when the PCP motor 152 is a diesel motor, etc.). The RTU may receive sensor data corresponding to electrical signals (e.g., control signals, etc.) provided to the PCP 150, the power provided to the PCP motor 152, an inlet pressure of the hydrocarbons below the helical rotor 154, an outlet pressure of the hydrocarbons above the helical rotor 154, and/or a temperature of the hydrocarbons flowing through the PCP 150.

In addition to the RTU 46 and the control engine 52 being able to communicate with the cloud-based computing system 12, remote data acquisition systems 56, third party systems 58, and database management systems 60 may communicatively couple to the cloud gateway 22. The remote data acquisition systems 56 may acquire real-time data transmitted by various data sources such as the RTU 46 and the third party systems 58. The database management system 60 may be a relational database management system that stores and retrieves data as requested by various software applications. By way of example, the database management system 60 may be a SQL server, an ORACLE server, an SAP server, or the like.

As mentioned above, the computing device 26 may communicatively couple to the RTU 46 and the cloud-based computing system 12. As shown in FIG. 3, the computing device 26 may include a mobile device, a tablet device, a laptop, a general purpose computer, or the like. In certain embodiments, the computing device 26 may communicatively couple with the remote data acquisition systems 56, the third party system 58, and the database management system 60. By communicating with all of these types of devices, the computing device 26 may receive data and generate visualizations associated with each respective device, thereby providing the user of the computing device 26 a more efficient manner in which to view and analyze the data. Moreover, since the computing device 26 may receive data from the cloud-based computing system 12, the computing device 26 may receive visualizations and data related to various types of analyses (e.g., emissions calculations and resource usage calculations) and cloud-based services 20 (e.g., emissions reporting and resource usage reporting) provided by the cloud-based computing system 12.

In some embodiments, the cloud-based computing system 12 may include applications related to collaboration or role based content, asset management, data models, visualizations, analysis & calculations, workflows, historical data, mobile web services, web services, and the like. The collaboration or role-based application may include facilitating collaboration between various users of the cloud-based computing system 12 to assist in the commission, operation, or maintenance of well devices at the hydrocarbon site 30. The asset management application may track the hardware and software maintenance of the well devices and the software used therein. The data model application may include algorithms that may simulate various types of data related to the production of hydrocarbons by a well device, the production of hydrocarbons at a hydrocarbon site, and the like based on various process parameter inputs received by the cloud-based computing system 12. The visualization application may generate various types of visualizations such as graphs, tables, data dashboards, and the like based on the data (e.g., emission and uncertainty data) received by the cloud-based computing system 12 and the data available to the cloud-based computing system 12 via the database 24 or the like.

The analysis & calculations applications may include software applications that may provide additional information regarding the data received by the cloud-based computing system 12. For example, the analysis and calculations applications may analyze the flow rate data regarding the production of hydrocarbons by the ALS 100 of a particular of the well sites 28 to determine the amount of hydrocarbons, water, and sand (i.e., multiphase measurements) contained in the produced hydrocarbons. In another example, analysis & calculations applications may determine emission data as described below. In yet another example, analysis & calculations applications may determine resource usage data as described below.

The workflow applications may be software applications that generate workflows or instructions for users of the well device or personnel at the hydrocarbon site 30 may use to perform their respective tasks. In one example, the cloud-based computing system 12 may generate a workflow regarding the monitoring of emissions, the monitoring of resource usage, the operation of the ALS 100 of the well sites 28, commissioning of a well device, troubleshooting an operation issue with a well device, or the like.

In certain embodiments, the workflow applications may determine the workflows based on historical data stored within the cloud-based computing system 12. That is, the historical data may include data related to previous items produced by any application within the cloud-based computing system 12 such as workflows, data analyses, reports, visualizations, and the like related emissions and uncertainty thereof. Moreover, the historical data may include raw data acquired by the RTU 46 or any other device and received by the cloud-based computing system 12. As such, the cloud-based computing system 12 may use the historical data to perform additional analyses on the received data, simulate or predict how the operations of a well device may change, simulate how the production of hydrocarbons at the well sites 28 may change, emissions at the well sites 28, resource usage at the well sites 28 and the like.

The cloud-based computing system 12 may provide mobile web services and web services that may enable the computing device 26, or any other device communicatively coupled to the cloud-based computing system 12, to access the Internet, Intranet, or any other network that may be available. Moreover, the cloud-based computing system 12 may use the web services to access information related to various analyses that it may be performing and the like.

### Emission System

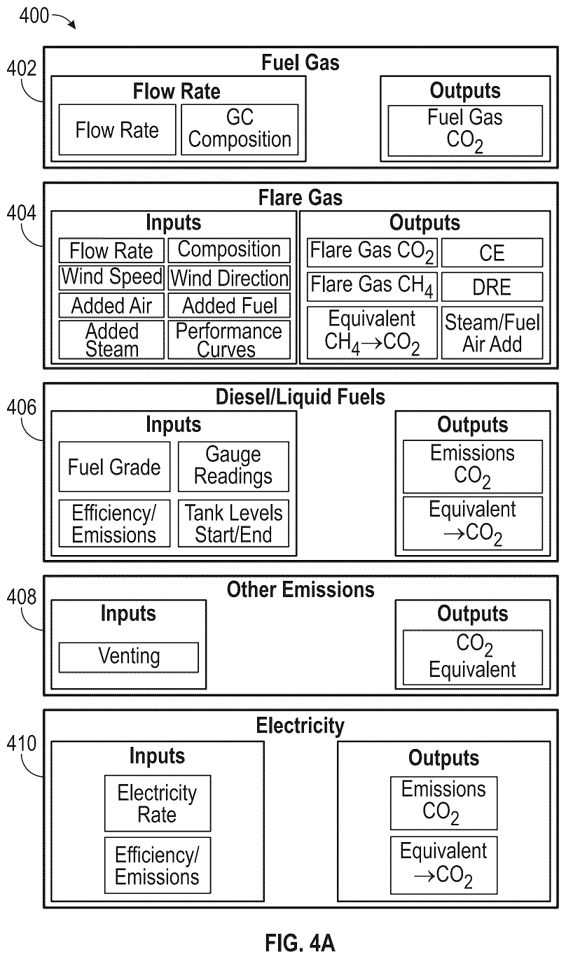

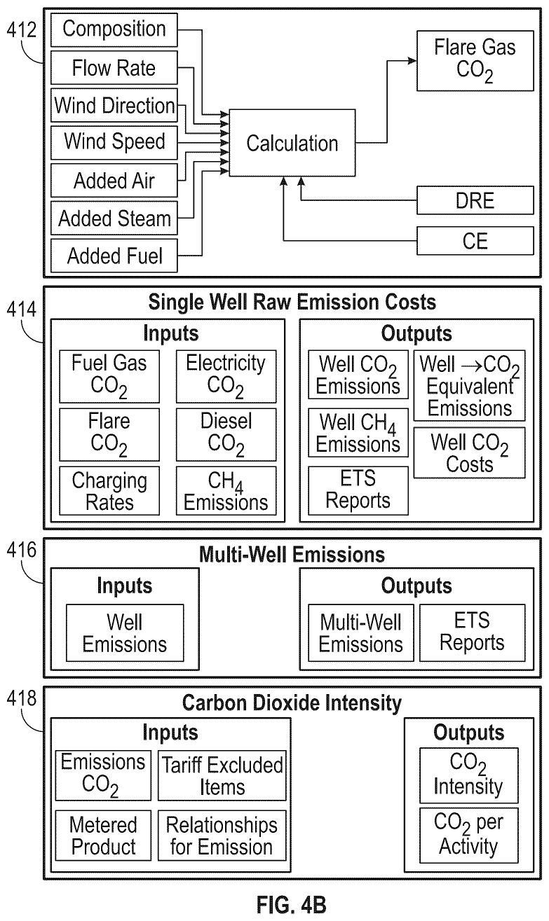

With reference to FIG. 4, system 12 can be configured to determine emissions associated with an operation of the well site 28 (e.g., a hydrocarbon operation, operation of the well site 28, operation of the ALS 100, etc.) by implementing a system 400. In other embodiments, the computing device 26 and/or the RTU 46 can be configured to determine the emissions associated with the operation of the well site 28 by implementing the system 400. System 400 can be part of system 12 and include sensors and computing components discussed above to perform the analysis and reporting described below. In some embodiments, the system 400 is configured to determine the emissions associated with operation of the ALS 100. In other embodiments, the system 400 is configured to determine the emissions associated with a different operation (e.g., the well sites 28, the well tree 36 of the well sites 28, the wellhead distribution manifolds 38 of the hydrocarbon site 30, etc.). Advantageously, system 400 can allow for operators to adjust operations of the ALS 100 of the well sites 28 to reduce the emissions associated with the operation of the ALS 100. Additionally or alternatively, system 400 may advantageously allow for operators to compare the emissions associated with the operation of the ALSs 100 of multiple of the well sites 28 and operate each of the ALSs 100 with according to different operational parameters to minimize an overall amount of the emissions associated with the operation of the ALSs 100 of the multiple of the well sites 28.

System 400 includes a fuel gas module 402, a flare gas module 404, a diesel fuel module 406, an emissions module 408, an electricity module 410, a flare emissions calculation module 412, a single well raw emissions cost calculator 414, a multi-well emissions calculator 416, and a carbon dioxide intensity calculator 418, according to some embodiments. In other embodiments, the system 400 includes a greater or lesser number of modules. Fuel gas module 402 receives data representative of flow rate and gas chromatography (CT) composition of the gas utilized to power equipment of the well sites 28. In some embodiments, fuel gas module 402 receives data representative of flow rate and gas chromatography (CT) composition of the gas utilized for powering the ALS 100 (e.g., the natural gas utilized to power the compressor 134 of the GL 130, etc.) such that the output of fuel gas module 402 may represent a portion of the emissions associated with the operation of the ALS 100 of the well sites 28. Flare gas module 404 receives data representative of flow rate, composition, added air quantity or rate, added steam quantity or rate, added fuel quantity or rate, and performance curves for the flaring operation. In some embodiments, the flare gas module 404 receives data representative of weather at the site including but not limited to wind speed and wind direction. Flare gas module 404 provides a flare gas carbon dioxide output, a flare gas methane output, a methane to carbon dioxide equivalent output, an added air, fuel, and steam output, a combustion efficiency output, and a destruction and removal efficiency output. These outputs can be made based upon readings from sensors such as multi-spectral infrared (IR) imagers or other analyzers that measure relative concentrations of unburned hydrocarbons, product of combustion (i.e., carbon dioxide), and product of incomplete combustion represented by carbon monoxide (CO). In some embodiments, the outputs and data received by the flare gas module 404 may be associated with the ALS 100 of the well sites 28 (e.g., the flow rate to a flare produced by the ALS 100 of the well sites 28, the composition of the gas entering the flare produced by the ALS 100 of the well sites 28, etc.) such that the outputs of the flare gas module 404 may represent a portion of the emissions associated with the operation of the ALS 100 of the well sites 28.

The diesel fuel module 406 receives data representative of fuel grade, gauge readings, efficiency and emissions, and tank start and stop levels and provides a carbon dioxide emission output associated with the use of diesel or other fuels at the well sites 28 and a carbon dioxide equivalent output (e.g., an equivalent carbon emission output, etc.). In some embodiments, the diesel fuel module 406 receives data representative to the liquid fuel utilized to power the ALS 100 (e.g., the diesel utilized to power the motor of the ESP 120, etc.) such that the output of the diesel fuel module 406 may represent a portion of the emissions associated with the operation of the ALS 100 of the well sites 28.

The emissions module 408 receives data representative of venting parameters and provides a carbon dioxide equivalent output (e.g., a carbon emission equivalent output, etc.) for the venting operation. In some embodiments, the data received by the emissions module 408 may be associated with the operation of the ALS 100 of the well sites 28 (e.g., the venting parameters that result from the performance of the ALS 100 of the well sites 28, etc.) such that the emissions module 408 provides the carbon dioxide equivalent output associated with the operation of the ALS 100 of the well sites 28. Electricity module 410 receives data representative of electricity usage and efficiency and emissions and provides a carbon dioxide emission output associated with the use of electricity at the well site and a carbon dioxide equivalent output. In some embodiments, the electricity for the well sites 28 is sourced from a supplier who provides the efficiency and emissions data to the electricity module 410. For example, the supplier may track efficiency related to the generation of the electricity that is provided to the well sites 28 and may provide efficiency data associated with generation of the electricity to the electricity module 410. In some embodiments, the electricity module 410 provides the carbon dioxide emission output associated with the use of electricity associated with the operation of the ALS 100 of the well sites 28 (e.g., the electricity required to operate the ALS 100, etc.) such that electricity module 410 provides the carbon dioxide equivalent output related to the operation of the ALS 100 of the well sites 28.

The flare emissions calculation module 412 receives the data received by flare gas module 404 and provides the flare gas carbon dioxide output, the combustion efficiency output, and the destruction and removal efficiency output provided by flare gas module 404. The flare emissions calculation module 412 determines the flare gas carbon dioxide output representing emissions associated with the flare operation. The flare emissions calculation module 412 can be part of flare gas module 404. In some embodiments, the data provided to the flare emissions calculation module 412 is related to the performance of the ALS 100 of the well sites 28 (e.g., the flow rate produced by the ALS 100, etc.) such that the flare gas carbon dioxide output may represent a portion of the emissions associated with the operation of the ALS 100 of the well sites 28.

The single well raw emissions cost calculator 414 receives flare gas carbon dioxide output by flare gas module 404, the diesel carbon dioxide output from diesel fuel module 406, the combustion efficiency output from flare gas module 404, and the destruction and removal efficiency output from flare gas module 404, the electricity carbon dioxide data received by electricity module 410, the fuel gas carbon dioxide output from fuel gas module 402, and the methane emission output from flare gas module 404. The single well raw emissions cost calculator 414 determines a well carbon dioxide output representing carbon dioxide emissions associated with the well sites 28, a site methane output representing methane emissions associated with the well sites 28, a site carbon dioxide equivalent output representing equivalent carbon dioxide emissions associated with the well sites 28, a site carbon dioxide cost output representing cost of carbon dioxide emissions associated with the well sites 28, and emission training systems (ETS) data associated with the well sites 28. The carbon dioxide equivalent output converts other emissions such as a methane to carbon dioxide equivalents so that the total emissions of the well sites 28 can be evaluated using carbon dioxide emissions as a scale. For example, if a single unit of methane is determined to be equivalent to ten units of carbon dioxide, the single well raw emissions cost calculator 414 may convert methane emissions into equivalent carbon dioxide emissions by multiplying an amount of the methane emissions by ten. The ETS data can be provided in a report for submission to governing bodies associate with emission standards and trading. In some embodiments, the data provided to the single well raw emissions cost calculator 414 from the flare gas carbon dioxide output by flare gas module 404, the fuel gas carbon dioxide from diesel fuel module 406, the combustion efficiency output from flare gas module 404, and the destruction and removal efficiency output from flare gas module 404, the electricity carbon dioxide data received by electricity module 410, the fuel gas carbon dioxide output from fuel gas module 402, and the methane emission output from flare gas module 404 is associated with the operation of the ALS 100 of the well sites 28 such that the total emissions of the single well raw emissions cost calculator 414 may be associated with the operation of the ALS 100 of the well sites 28.

The multi-well emissions calculator 416 determines a multi-well or network emissions output representing emissions associated with multiple of the well sites 28, and ETS data associated with multiple of the well sites 28. The emissions output or data can represent carbon dioxide equivalent output or a combination of carbon dioxide and other emissions such as a methane. In some embodiments, the emissions data includes carbon dioxide equivalents so that total emissions for multiple of the well sites 28 can be determined. In some embodiments, the data provided to the multi-well emissions calculator 416 is associated with the operation of each of the ALSs 100 of multiple of the well sites 28 such that the total emissions for multiple of the well sites 28 may associated with the operation of each of the ALSs 100 of multiple of the well sites 28. In some embodiments, the well sites 28 are located in one of the hydrocarbon sites 30. In other embodiments, the well sites 28 may be located in more than one of the hydrocarbon sites 30.

The carbon dioxide intensity calculator 418 receives a carbon dioxide output representing carbon dioxide emissions associated with one of the well sites 28 or multiple of the well sites 28, a metered product measurement representing product (e.g., natural gas) production associated with one of the well sites 28 or multiple of the well sites 28, tariff excluded items data representing products that are not under carbon tariffs, and relationships for emissions data representing the relationships of products to the emissions data. The carbon dioxide intensity calculator 418 determines the well sites 28 or multiple of the well sites 28 carbon dioxide intensity output and the well sites 28 or multiple of the well sites 28 carbon dioxide per activity output. Emission intensity is defined as carbon dioxide emissions and/or carbon dioxide equivalent emissions (e.g., the carbon dioxide equivalent of methane emissions, etc.) per a unit of production or economic value. In some embodiments, the data provided to the carbon dioxide intensity calculator 418 is associated with the operation of the ALS 100 of the well sites 28 such that the emission intensity and/or the emissions per activity output may be associated with the operation of the ALS 100 of the well sites 28. For example, for the ALS 100, the emission intensity may be an amount of carbon dioxide emissions associated with the ALS 100 that are generated for every barrel of crude oil that is lifted by the ALS 100. In various embodiments, the data provided to the carbon dioxide intensity calculator 418 is associated with the operation of each of the ALSs 100 of multiple of the well sites 28 such that the emission intensity and/or the carbon dioxide per activity output is associated with the operation of each of the ALSs 100 of multiple of the well sites 28.

In some embodiments, the system 400 is configured to generate emission display data corresponding to the emissions and/or the emission intensity associated with the operations of the well site 28. By way of example, the system 400 may generate the emission display data corresponding to the emissions and/or the emission intensity of a single of the well sites 28 based on the outputs of the single well raw emissions cost calculator 414 and/or the carbon dioxide intensity calculator 418 and provide the emission display data to at least one of the computing devices 26 to be displayed to an operator of the single of the well sites 28. By way of another example, the system 400 may generate the emission display data corresponding to the emissions and/or the emission intensity of multiple of the well sites 28 based on the outputs of the multi-well emissions calculator 416 and/or the carbon dioxide intensity calculator 418 and provide the emission display data to at least one of the computing devices 26 to be displayed to an operator of the multiple of the well sites 28.

In some embodiments, the system 400 may generate the emission display data in substantially real time (e.g., as the emissions are outputted by the well site 28, etc.) and provide the emission display data to the at least one of the computing devices 26. Displaying the emission display data in a live dashboard allows operators adjust operations to reduce the emissions of the operations. For example, a first of the well sites 28 with a first of the ALS 100 producing higher emissions than a second of the well sites 28 with a second of the ALS 100 may indicate that the first of the ALS 100 should be run at a lower flow rate than the first of the ALS 100 to reduce the overall emissions of multiple of the well sites 28. In another example, if the first of the well sites 28 with the first of the ALS 100 producing a higher emission intensity than the second of the well sites 28 with the second of the ALS 100, than the production of the second of the well sites 28 should be increased to reduce a combined higher emission intensity of multiple of the well sites 28.

In some embodiments, the system 400 is configured to generate and provide the emission display data to the at least one of the computing devices 26 in response to at least a portion of the emission data exceeding an emission threshold. By way of example, the system 400 may generate and provide the emission display data to the computing devices 26 in response to the emissions exceeding an emission threshold. By way of another example, the system 400 may generate and provide the emission display data to the computing devices 26 in response to the emission intensity exceeding an emission intensity threshold. As a result, operators of the well site 28 may be made aware when the portions of the emission data exceed the emission threshold such that the operators may modify the operation of the well site 28 to bring the portions of the emission data below the emission threshold. By way of example, the operators of the well site 28 may identify components that are “bad actors” that are generating a higher amount of emissions than expected based on the display data identifying the portions of the emission data that exceed the emission threshold.

In some embodiments, system 400 is configured to generate and provide reports for viewing on any of the computing devices 26 (FIG. 1). For example, all generated data can be aggregated into a fiscal report which provides combined emission totals for an operation, a site, multiple sites, a venture, a regions, etc. In some embodiments, an emission intensity report can provide cost per production values (e.g., dollars of emission costs per dollars of product or weight of product produced).

### Resource Usage System

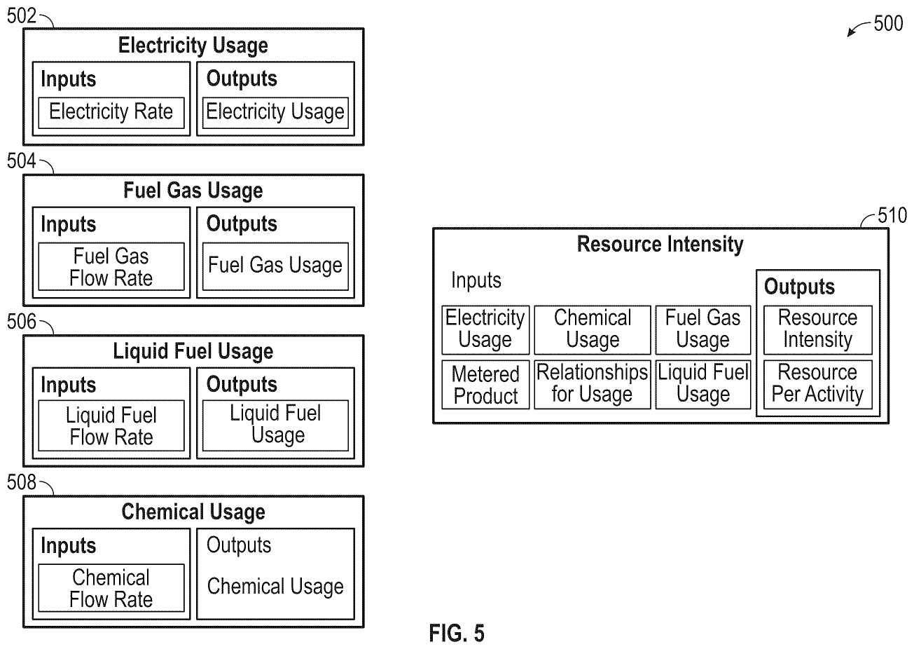

With reference to FIG. 5, system 12 can be configured to determine resource usage associated with operation of the well site 28 by utilizing a system 500. In other embodiments, the computing device 26 can be configured to determine the resource usage of the operation of the well site 28 by utilizing the system 500. System 500 can be part of system 12 and include sensors and computing components discussed above to perform the analysis and reporting described below. In some embodiments, the system 500 is configured to determine the resource usage associated with the operation of the ALS 100 of one of the well sites 28. In other embodiments, the system 500 is configured to determine the resource usage associated with a different operation (e.g., the well tree 36 of the well sites 28, the wellhead distribution manifolds 38 of the hydrocarbon site 30, etc.). Advantageously, system 500 can allow for operators to adjust operations of the ALS 100 of the well sites 28 to reduce and/or optimize the resource usage of the operation. In some embodiments, system 500 can allow for operators to advantageously reduce the resource usage of specific resources (e.g., chemicals, diesel, electricity, etc.) associated with the operation of the ALS 100. Additionally or alternatively, system 500 may advantageously allow for operators to compare the ALS 100 of multiple of the well sites 28 and operate each of the ALSs 100 with different parameters to minimize and/or optimize an overall resource usage of the multiple of the well sites 28.

System 500 includes an electricity usage module 502, a fuel gas usage module 504, a liquid fuel usage module 506, a chemical usage module 508, and a resource usage intensity calculator 510. Electricity usage module 502 receives data representative of the electricity rate (e.g., the rate of electricity provided to a motor, the rate of electricity provided to a separator to separate water from hydrocarbons, etc.) and provides an electricity usage for the electricity being used by the well sites 28. In some embodiments, the electricity usage module 502 is associated with the operation of the ALS 100 of the well sites 28 (e.g., the electricity rate required to run a pump of the ESP 120, the electricity rate required to run a compressor of the GL 130, etc.) such that the electricity usage provided by the electricity usage module 502 may be associated with the operation of the ALS 100 of the well sites 28.

Fuel gas usage module 504 receives data representative of the fuel gas flow rate (e.g., the fuel gas flow rate provided to a generator, etc.) and provides a fuel gas usage for the fuel gas being used by the well sites 28. In some embodiments, the fuel gas usage module 504 is associated with the operation of the ALS 100 of the well sites 28 (e.g., the fuel gas flow rate required to run a compressor of the GL 130, etc.) such that the fuel gas usage provided by the fuel gas usage module 504 may be associated with the operation of the ALS 100 of the well sites 28.

Liquid fuel usage module 506 receives data representative of the liquid fuel flow rate (e.g., the liquid fuel flow rate provided to a generator, etc.) and provides a liquid fuel usage for the liquid fuel being used by the well sites 28. In some embodiments, the liquid fuel usage module 506 is related to the performance of the ALS 100 of the well sites 28 (e.g., the liquid fuel flow rate required to run a compressor of 506 the GL 130, etc.) such that the liquid fuel usage provided by the liquid fuel usage module 506 may be related to the performance of the ALS 100 of the well sites 28.

Chemical usage module 508 receives data representative of the chemical flow rate (e.g., the chemical flow rate provided to a chemical injector, etc.) and provides a chemical usage for the chemicals being used by the well sites 28. In some embodiments, the chemical usage module 508 is associated with the operation of the ALS 100 of the well sites 28 (e.g., the chemical flow rate being injected by the GL 130, etc.) such that the chemical usage provided by the chemical usage module 508 may be associated with the operation of the ALS 100 of the well sites 28.

The resource usage intensity calculator 510 receives the electricity usage to operate single sites or multiple sites from the electricity usage module 502, the fuel gas usage to operate single sites or multiple sites from the fuel gas usage module 504, the liquid fuel usage to operate single sites or multiple sites from the liquid fuel usage module 506, the chemical usage to operate single sites or multiple sites from the chemical usage module 508, a metered product measurement representing product (e.g., natural gas, crude oil, etc.) production associated with the single sites or multiple sites, and relationships for resource data representing the relationships of products to the resource data. The resource usage intensity calculator 510 determines a multi-site or single site resource intensity output for each resource and a multi-site or single site resource per activity output for each resource. Resource intensity is defined as resource usage per a unit of production or economic value. In some embodiments, the data provided to the resource usage intensity calculator 510 is associated with the operation of the ALS 100 of the well sites 28 such that resource intensity for each resource or the resource per activity for each resource of the resource usage intensity calculator 510 may be associated with the operation of the ALS 100 of the well sites 28 or associated with the operation of each of the ALSs 100 at multiple of the well sites 28. For example, for the ALS 100, the resource intensity may be an amount of resources associated with the ALS 100 that are consumed (e.g., utilized to generate electricity, outputted by the ALS 100, consumed to operate the ALS 100, etc.) for every barrel of crude oil that is lifted by the ALS 100.

In some embodiments, the system 500 is configured to generate resource usage display data corresponding to the resource usage and/or the resource usage intensity associated with the operations of the well site 28. By way of example, the system 500 may generate the resource usage display data corresponding to the resource usage and/or the resource usage intensity of a single of the well sites 28 based on the outputs of the resource usage intensity calculator 510. In some embodiments, the system 500 may generate the resource usage display data in substantially real time (e.g., as the resources are being consumed by the well site 28, etc.) and provide the resource usage display data to the at least one of the computing devices 26. Displaying the resource usage in a live dashboard may allow for operators adjust operations to reduce the resource usage of the operations. For example, if a first of the well sites 28 with a first of the ALS 100 has a higher resource usage than a second of the well sites 28 with a second of the ALS 100, the first of the ALS 100 may be run at a lower flow rate than the second of the ALS 100 in order to reduce a combined resource usage of the first of the ALS 100 and the second of the ALS 100. In another example, if the first of the well sites 28 with the first of the ALS 100 is operating with a first resource intensity and the second of the well sites 28 with the second of the ALS 100 is operating with a second resource intensity that is lower than the first resource intensity, the operation of the first of the ALS 100 should be reduced in order to reduce a combined resource intensity of the first of the ALS 100 and the second of the ALS 100.

In some embodiments, the system 500 is configured to generate and provide the resource usage display data to the at least one of the computing devices 26 in response to at least a portion of the resource usage data exceeding a resource usage threshold. By way of example, the system 500 may generate and provide the resource usage display data to the computing devices 26 in response to a usage of a resource exceeding a resource usage threshold. By way of another example, the system 500 may generate and provide the resource usage display data to the computing devices 26 in response to the resource usage intensity exceeding a resource usage intensity threshold. As a result, operators of the well site 28 may be made aware when portions of the resource usage data exceed the resource usage threshold such that the operators may modify the operation of the well site 28 to bring the portions of the resource usage data below the resource usage threshold. By way of example, the operators of the well site 28 may identify components that are “bad actors” that are generating a higher amount of emissions than expected based on the display data identifying the portions of the emission data that exceed the emission threshold.

In some embodiments, system 500 can provide reports for viewing on any of the computing devices 26 (FIG. 1). For example, all generated data can be aggregated into a resource report which provides combined resource cost totals for an operation, a site, multiple sites, a venture, a regions, etc. In some embodiments, a resource intensity report can provide resource usage of each resource per production values (e.g., a weight or a volume of a resource per dollars of product or weight of product produced).

### Low Level Optimization Process

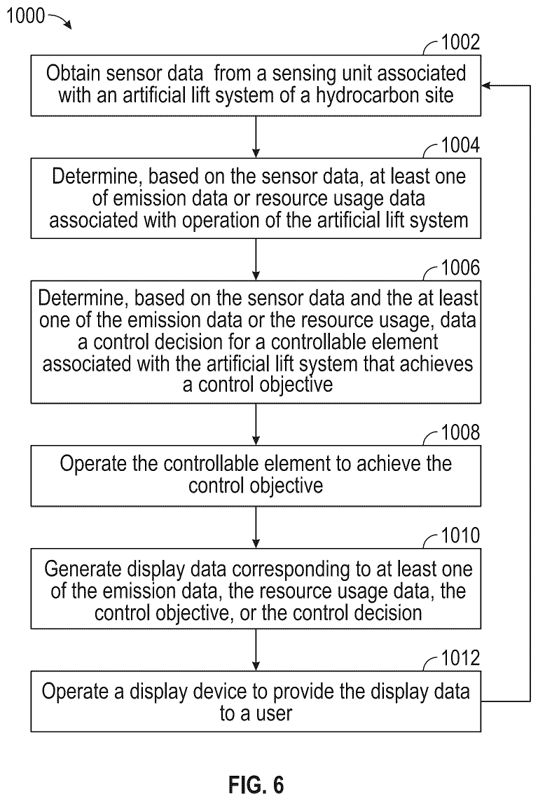

Referring now to FIG. 6, a flow diagram of a process 1000 for operating controllable elements associated with an artificial lift system of a hydrocarbon site to achieve control objectives is shown, according to some embodiments. Process 1000 includes steps 1002-1012 and can be performed by the system 12 and/or the computing devices 26, according to some embodiments. In other embodiments, process 1000 can be performed by the RTU 46. In some embodiments, process 1000 is configured to optimize operation of a well site system with an ALS using real-time sensor data and predetermined objectives. In other embodiments, process 1000 is for operating controllable elements associated with other systems of the hydrocarbon site (e.g., separators, manifolds, compressors, etc.) to achieve control objectives.

Process 1000 includes obtaining (e.g., acquiring, etc.) sensor data from a sensing unit associated with an artificial lift system of a hydrocarbon site (step 1002), according to some embodiments. In some embodiments, the sensor data includes temperature, pressure, flow rate, and composition of a gas flowing through the artificial lift system from one or more sensing units that are associated with the artificial lift system. For example, when the ALS 100 is configured as the GL 130, the sensor data may correspond with the gas that is inserted by the GL 130 into the hydrocarbon fluid to decrease the density of the hydrocarbon fluid. In some embodiments, step 1002 is performed by the RTU 46. The sensor data can be provided from the RTU 46 to the control engine 52, to the computing devices 26, and/or to the system 12, according to some embodiments. In some embodiments, process 1000 includes obtaining sensor data relating to the performance of the ALS 100 of the well sites 28 (e.g., the temperature of the hydrocarbons flowing through the ALS 100, the flow rate of hydrocarbons flowing through the ALS 100, etc.).

Process 1000 includes determining, based on the sensor data, at least one of emission data and/or resource usage data associated with operation of the artificial lift system (step 1004), according to some embodiments. Step 1004 may utilize one or more systems to determine the emission data and/or the resource usage data associated with the operation of the artificial lift system. For example, step 1004 may utilize system 400 to determine the emission data including the emissions and/or the emission intensity associated with the operation of the ALS 100. As another example, step 1004 may utilize system 500 to determine the resource usage data including the resource usage and/or the resource usage intensity associated with the operation of the ALS 100. Step 1004 is performed by the system 12 and/or the computing devices 26, according to some embodiments.

Process 1000 includes determining, based on the sensor data and the at least one of the emission data or the resource usage data, a control decision for a controllable element associated with the artificial lift system that achieves a control objective (step 1006), according to some embodiments. Step 1006 may include performing closed loop control using the sensor data and an emission system and/or a resource usage system to determine the control decision that achieves the control objective. In some embodiments, the sensor data that is used in step 1006 includes the temperature, pressure, and flow rate of fluids associated with the operation of the artificial lift system (e.g., fuel gas, hydrocarbon fluid, gases, etc.). In some embodiments, step 1006 is performed by the system 12 and/or the computing devices 26. In various embodiments, step 1006 is performed utilizing the system 1100, discussed in more detail herein. By way of example, step 1006 may utilize the system 1100 to optimize the operation of the artificial lift system according to the control objective in order to determine the control decision for the controllable element that achieves the control objective. The control objective and the emission data and/or the resource usage data may be inputted into the system 1100 and the system 1100 may optimize the control decision for the controllable element that achieves the control objective.

In some embodiments, the control objective includes at least one of reducing resource usage associated with the artificial lift system to a predetermined threshold, reducing resource usage intensity associated with the artificial lift system to a predetermined rate, reducing emission associated with the artificial lift system to a predetermined threshold, or reducing emission intensity associated with the artificial lift system to a predetermined rate. The controllable decision is associated with the operation of at least one of the controllable elements associated with the ALS 100. For example, the controllable decision may be to reduce flow rate of fluid outputted by the compressor 134 of the ESP 120 to reduce an amount of resources consumed to operate the compressor 134 when the control objective includes reducing resource usage associated with the ALS 100. As another example, the controllable decision may be to increase the rotations per minute of the helical rotor 154 of the PCP 150 to increase a production rate of hydrocarbons of the PCP 150 when the control objective includes reducing resource usage intensity associated with the ALS 100 (e.g., when increasing the production rate increases an amount of hydrocarbons at a faster rate than an amount of resources consumed to operate the PCP 150, etc.). As yet another example, the controllable decision may be to decrease an amount of gas injected by the GL 130 when the control objective includes reducing a resource usage associated with the ALS 100. The system 12 may implement a PID control scheme to determine control decisions to meet the control objectives, according to some embodiments.

In some embodiments, the control objective includes optimizing the operation of the artificial lift system to bring the emissions below an emission threshold and/or the emission intensity below an emission intensity threshold. By way of example, the well site 28 may typically produce more emissions during daytime due to an ambient temperature surrounding the well site 28 being higher during the daytime than the nighttime. As a result, step 1006 may include control decisions for the controllable elements of the well site 28 that cause certain emissions to be emitted during the nighttime instead of the day time, which may bring a maximum emission intensity of the well site 28 below the emission intensity threshold.

In some embodiments, the control objective includes optimizing the operation of the artificial lift system to bring the resource usage below a resource usage threshold and/or the resource usage intensity below a resource usage intensity threshold. By way of example, the well site 28 may have a maximum supply of electricity that can be provided to the well site 28 and the resource usage threshold may be the maximum supply of electricity. As a result, step 1006 may include control decisions for the controllable elements of the well site 28 that bring an electricity usage below the resource usage threshold. In some embodiments, the control decisions may include operating the controllable elements during non-peak periods of time. By way of example, the control decisions may include operating the controllable elements during the night time when demand for electricity is lower. As a result, additional electricity may be available to the well site 28 such that the resource usage may be kept below the resource usage threshold.

In some embodiments, step 1006 includes generating an action plan that includes control decisions for controllable elements of the well site 28. By way of example, the action plan may include control decisions for different of the controllable elements of the well site 28 such that the emissions are below the emission threshold, the emission intensity is below the emission intensity threshold, the resource usage is below the resource usage threshold, and/or the resource usage intensity is below the resource usage intensity threshold. By way of example, the action plan may include operating different of the controllable elements of the well site 28 at different times to reduce an amount of emissions and/or resource usage at any given time.

In some embodiments, step 1006 includes generating a maintenance plan for the well site 28. By way of example, step 1006 may include determining that performing maintenance on one of the controllable elements of the well site 28 would cause the emissions to be below the emission threshold, the emission intensity to be below the emission intensity threshold, the resource usage to be below the resource usage threshold, and/or the resource usage intensity to be below the resource usage intensity threshold. As a result, the maintenance plan may allow for operators to determine when and/or where to perform maintenance in order to ensure optimal operation of the well site 28.

Process 1000 includes operating the controllable element to achieve the control objective (step 1008), according to some embodiments. In some embodiments, step 1008 includes providing the control decision from system 12 to the ALS 100. In some embodiments, the controllable well site elements include injection systems for pumping or injecting an additive to the fluid, a heating element (e.g., a heating coil), a cooling element, a compressor, a separator, etc. In some embodiments, step 1008 is automatically performed. By way of example, the RTU 46 may operate the ALS 100 according to the control decision to automatically to achieve the control objective. In other embodiments, step 1008 is manually performed. By way of example, the control decision for the controllable element of the ALS 100 determined in step 1006 may be provided to an operator of the well site 28 and the operator may manually authorize the RTU 46 to operate the controllable element the ALS 100 according to the control decisions and/or the operator may manually operate the controllable element of the ALS 100 according to the control decisions in order to achieve the control objective. In still other embodiments, the process 1000 does not include step 1008. By way of example, the process 1000 may not include step 1008 when the process 1000 is configured to display the sensor data, the control objective, and/or the control decision to an operator so that the operator can analyze the sensor data, the control objective, and/or the control decision and determine (e.g., manually determine, etc.) how to operate the ALS 100.

Process 1000 includes generating display data corresponding to at least one of the emission data, the resource usage data, the control objective, or the control decision (step 1010), according to some embodiments. In some embodiments, the display data corresponds to resource usage cost, resource intensity, emissions, and/or emission intensity associated with the artificial lift system. In some embodiments, the controllable decisions include reducing the operating speed of a motor, decreasing the flow rate of a chemical, etc. In some embodiments, step 1010 generates display data related to the operation of the ALS 100 of the well sites 28. In some embodiments, the system 400 is utilized to generate the emission data. In some embodiments, the system 500 is utilized to generate the resource usage data.

In some embodiments, the display data may include patterns (e.g., trends, etc.) identified in the emission data and/or the resource usage data. By way of example, if the emission data includes a spike in the emissions of the well site 28 at a certain time every day, the display data may include an emission pattern corresponding to the display data that identifies the spike in the emissions of the well site 28. In some embodiments, the system 400 may be utilized to determine patterns associated with the emission data. In some embodiments, the system 500 may be utilized to determine the patterns associated with the resource usage data.

In some embodiments, the display data may include forecasts (e.g., predictions, etc.) associated with the emission data and/or the resource data. The forecasts may be determined based on the patterns identified in the emission data and/or the resource usage data and/or based on user inputs associated with the emission data and/or the resource usage data. By way of example, if the resource usage data includes a pattern that indicates that the resource usage of the well site 28 increases as an ambient temperature increases, the display data may include a forecast associated with a future timeframe that includes increased resource usage based on an increase in temperature in the future timeframe. By way of another example, if the emission data includes a pattern that indicates that the emissions of the well site 28 increase when the well site 28 is processing a heavier stream of hydrocarbons, the display data may include a forecast associated with a future timeframe that includes increased emissions based on receiving a user input indicating that the well site 28 will be processing a heavy stream of hydrocarbons during the future time frame. The system 400 may be utilized to determine emission forecasts associated with the emissions and/or the emission intensity of the well site 28. The system 500 may be utilized to determine resource usage forecasts associated with the resource usage and/or the resource intensity of the well site 28.

In some embodiments, the display data may include savings associated with the emission data and/or the resource usage data based on the control decisions for the controllable elements associated with the artificial lift system that achieves the control objective. By way of example, the emission data and/or the resource usage data before applying the control decision may be compared with the emission data and/or the resource usage data after applying the control decision to determine the savings associated with the control decision. Savings associated with the emissions and/or the emission intensity may include an amount that the emissions and/or the emission intensity is reduced by as a result of applying the control decision. Savings associated with the resource usage and/or the resource usage intensity may include an amount that the resource usage and/or the resource usage intensity is reduced by as a result of applying the control decisions. In some embodiments, the savings associated with the emission data may be determined by the system 400 by determining and comparing the emission data prior to applying the control decision and the emission data after applying the control decision. In some embodiments, the savings associated with the resource usage data may be determined by the system 500 by determining and comparing the resource usage data prior to applying the control decision and the resource usage data after applying the control decision. In some embodiments, the savings may be forecasted savings associated with forecasted changes in the emission data and/or the resource usage data based on the control decisions.

Process 1000 includes operating a display device to provide the display data to a user (step 1012), according to some embodiments. In some embodiments, the display device is any of the computing devices 26 (FIG. 1). In some embodiments, the display device is configured to access the display data via a server or a webpage. In some embodiments, step 1012 operates the display device to provide the display data related to the operation of the ALS 100 of the well sites 28 to the user.

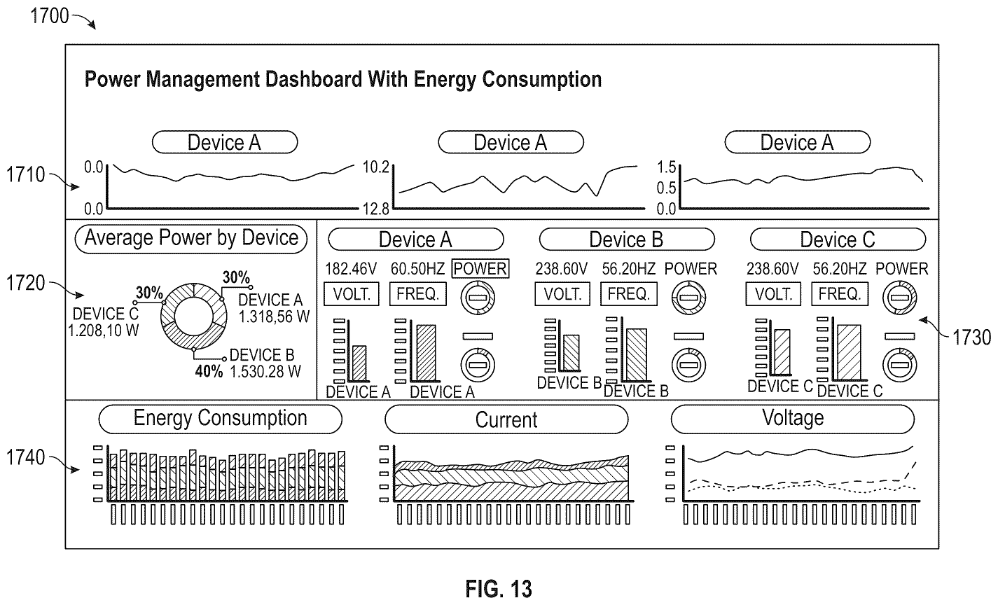

As in FIG. 13, the process 1000 operates the display device to provide the display data to the user in step 1012 by generating and providing a display interface 1700 (e.g., a graphical display interface, a graphical user interface, etc.) corresponding to the display data to the display device. The display interface 1700 corresponds to the display data generated during step 1010. In some embodiments, the display interface 1700 is generated by at least one of the system 400 or the system 500.

According the exemplary embodiment shown in FIG. 13, the display interface 1700 corresponds to the display data corresponding to the resource usage data. As shown in FIG. 13, the display interface 1700 includes a plurality of resource usage graphs 1710 indicating the resource usage associated with various of the well devices of the well site 28. The display interface 1700 shows a first of the resource usage graphs 1710 corresponding to the resource usage of a first of the well devices of the well site 28, a second of the resource usage graphs 1710 corresponding to a second of the well devices of the well site 28, and a third of the resource usage graphs 1710 corresponding to a third of the well devices of the well site 28. As a result, an operator may observe the resource usage graphs 1710 to visualize trends in the resource usages of the various well devices of the well site 28. In various embodiments, the display interface 1700 includes a plurality of emission graphs indicating the emissions associated with various of the well devices of the well site 28.

As shown in FIG. 13, the display interface 1700 includes an resource usage comparison chart 1720 indicating portions of the resource usage of the well site 28 that are associated with the well devices of the well site 28. By way of example, the resource usage comparison chart 1720 may indicate that a first portion of the resource usage of the well site 28 is associated with a first of the well devices, a second portion of the resource usage of the well site 28 is associated with a second of the well devices, and a third portion of the resource usage of the well site 28 is associated with a third of the well devices. In various embodiments, the display interface 1700 includes an emission chart indicating the portions of the emissions of the well site 28 that are associated with the well devices of the well site 28.

As shown in FIG. 13, the display interface 1700 includes resource usage elements 1730 corresponding to portions of the resource usage of the well site 28 that are associated with the well devices of the well site 28. In some embodiments, the resource usage elements 1730 may indicate a live resource usage associated with the well devices of the well site 28. By way of example, each of the resource usage elements 1730 may include a voltage associated with an electricity usage of the well devices, a frequency associated with the electricity usage of the well devices, a power being consumed by the well devices, and/or a current draw associated with the well devices. In various embodiments, the display interface 1700 includes emission elements corresponding to portions of the emissions of the well site 28 that are associated with the well devices of the well site 28.

As shown in FIG. 13, the display interface 1700 includes resource usage tracking elements 1740 corresponding to tracking different components of the resource usage of the well site 28. By way of example, a first of the resource usage tracking elements 1740 may be associated with an energy consumption of the well site 28, a second of the resource usage tracking elements 1740 may be associated with a current draw of the well site 28, and a third of the resource usage tracking elements 1740 may be associated with a voltage draw of the well site 28. In some embodiments, the resource usage tracking elements 1740 may include indications indicating the portions of the difference components of the resource usage of the well site 28 that are associated with the well devices of the well site 28. For example, each of the resource usage tracking elements 1740 may include a first component corresponding to a first portion of the resource usage associated with a first of the well devices, a second component corresponding to a second portion of the resource usage associated with a second of the well devices, and a third component corresponding to a third portion of the resource usage associated with a third of the well devices. In various embodiments, the display interface 1700 includes emission tracking elements corresponding to tracking different components of the emissions of the well site 28.

### Optimization Controller

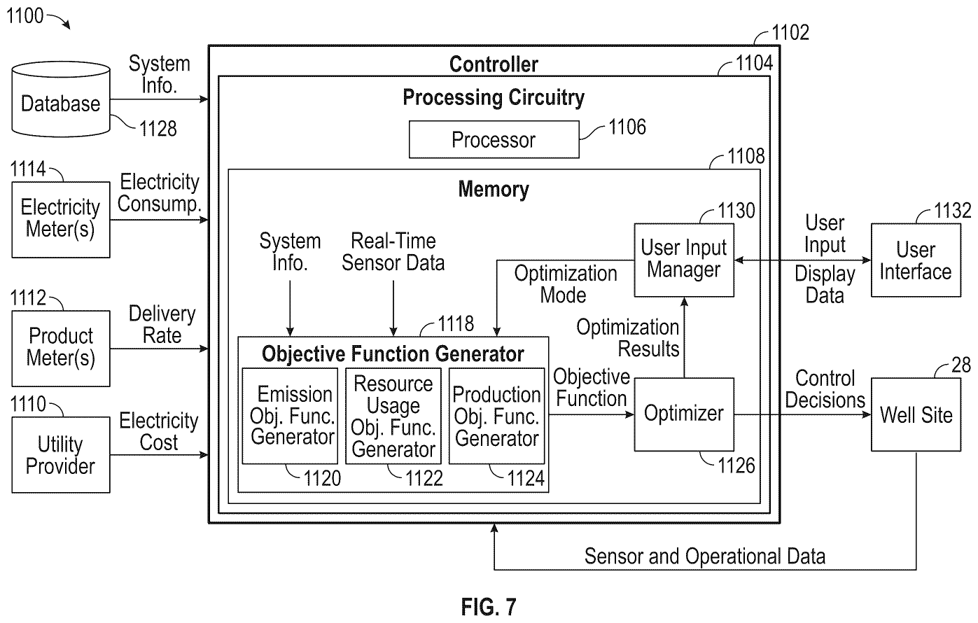

Referring particularly to FIG. 7, a system 1100 for optimizing operation of the well site 28 is shown, according to some embodiments. In some embodiments, the system 1100 is configured to generate control decisions for the well sites 28 to operate the well sites 28, equipment, pumps, chemical injections, etc., optimally. In some embodiments, the well sites 28 includes the ALS 100 and the system 1100 is configured to generate control decisions associated with the ALS 100 in order to optimize the operation of the ALS 100 according to control objectives associated with the ALS 100. In some embodiments, the system 1100 includes a controller 1102, a database 1128, electricity meters 1114, product meters 1112, a user interface 1132, and the well sites 28. In some embodiments the controller 1102 may be the system 12, the RTU 46, and/or the computing devices 26. In some embodiments, the database 1128 is stored locally on the controller 1102 or stored on a cloud computing system. In some embodiments the database 1128 may be the database 24. In some embodiments, the electricity meters 1114 and the product meters 1112 are components or sensors of the well sites 28. In some embodiments, the controller 1102 is configured to receive system information of the well sites 28 from the database 1128, electricity consumption data of various components of the well sites 28 from the electricity meters 1114, delivery rate or quantity data from the product meters 1112 of the well sites 28, electricity costs, forecasts, or schedules from a utility provider 1110, and sensor and/or operational data from the well sites 28 or sensors thereof (e.g., pressure sensors, flow meters, temperature sensors, etc.). In some embodiments, the controller 1102 is configured to receive one or more user inputs from the user interface 1132 indicating a desired optimization mode for the controller 1102. In some embodiments, the user interface 1132 may be the computing device 26 (e.g., a personal computer, a cell phone, etc.). In some embodiments, the controller 1102 is configured to operate the user interface 1132 to display optimization results. In some embodiments, the controller 1102 is configured to provide control decisions to the well sites 28 to operate the well sites 28 according to the control decisions that are generated as a result of the optimization. In some embodiments, if electricity meters 1114 are not provided or used, electric use can be estimated based on process conditions and pump curves (e.g., integrating an amount of energy consumed over time). In some embodiments, the electric use is calculated by the controller 1102. In some embodiments, the system 1100 may be used to optimize operations of multiple of the well sites 28.

The controller 1102 includes processing circuitry 1104 including a processor 1106 and a memory 1108. The processor 1106 can be a general purpose or specific purpose processor, an application specific integrated circuit (ASIC), one or more field programmable gate arrays (FPGAs), a group of processing components, or other suitable processing components. The processor 1106 may be configured to execute computer code and/or instructions stored in the memory 1108 or received from other computer readable media (e.g., CDROM, network storage, a remote server, etc.).

The memory 1108 can include one or more devices (e.g., memory units, memory devices, storage devices, etc.) for storing data and/or computer code for completing and/or facilitating the various processes described in the present disclosure. The memory 1108 can include random access memory (RAM), read-only memory (ROM), hard drive storage, temporary storage, non-volatile memory, flash memory, optical memory, or any other suitable memory for storing software objects and/or computer instructions. The memory 1108 can include database components, object code components, script components, or any other type of information structure for supporting the various activities and information structures described in the present disclosure. The memory 1108 can be communicably connected to the processor 1106 via the processing circuitry 1104 and can include computer code for executing (e.g., by the processor 1106) one or more processes described herein.

Referring still to FIG. 7, the memory 1108 includes an objective function generator 1118, an optimizer 1126, and a user input manager 1130, according to some embodiments. In some embodiments, the objective function generator 1118 is configured to receive a desired or selected optimization mode from the user input manager 1130 as provided by the user input. In some embodiments, the objective function generator 1118 includes a resource objective function generator 1120, an emission objective function generator 1122, and a production objective function generator 1124. The objective function generator 1118 is configured to receive system information and/or real-time sensor data to generate the objective function according to the optimization mode, according to some embodiments. In some embodiments, the system information is the system information provided by the database 1128. The system information can include information regarding equipment, equipment models, inter-relationships between the different equipment, pumps, etc., layout, etc., of the well sites 28 and the ALS 100. In some embodiments, the system information includes models of multiple of the well sites 28 (e.g., models of each of the well sites 28, etc.), or mathematical models of the various components of the equipment of the well sites 28. For example, the models of the well sites 28 may be equipment performance curves, mathematical equations, multi-dimensional graphs, etc., showing modeled or predicted operation of the well sites 28 with the ALS 100 with respect to different control decisions (e.g., an amount of emissions that the well sites 28 with the ALS 100 produces if operated to lift the product with a particular flow rate, an amount of resource usage that the well sites 28 with the ALS 100 uses if operated to lift the product with a particular flow rate, etc.). In some embodiments, the system information includes information regarding differences in product make up between multiple of the well sites 28 (e.g., water content of the product, gas content of the product, etc.), depth difference between the well sites, etc. In some embodiments, the models of the well sites 28 predict or estimate one or more output variables (e.g., energy consumption, output flowrate, production rate of product, emissions, resource cost, etc.) as a function of one or more input variables (e.g., operating parameters of the ALSs 100, amount of energy consumed, power generation, weather data, type of product being produced, etc.).

In some embodiments, the real-time sensor data includes the electricity consumption, the delivery rate, the electricity costs, and/or the sensor and operational data. In some embodiments, the real-time sensor data is used by the objective function generator 1118 to generate the objective function.

When the optimization mode is selected to optimize emissions associated with the ALS 100, the objective function generator 1118 implements the emission objective function generator 1122 and generates an objective function that determines (e.g., quantitatively predicts, estimates, etc.) the emissions associated of the well sites 28 as a function of one or more control decisions (e.g., operation of the ALS 100) subject to one or more constraints. In some embodiments, the emission objective function generator 1122 utilizes system 400 as a portion of the objective function that quantitatively predicts or estimates emissions associated with the well sites 28 as a function of one or more control decisions based on sensor data and the inputs and outputs of system 400 described in more detail above. In some embodiments, the emission objective function generator 1122 generates an objective function that determines the emissions associated with the ALS 100 as a function of one or more control decisions associated with the ALS 100. In some embodiments, the objective function includes models of one or more of the ALS 100 or components of the ALS 100 (e.g., pump models, pump curves, compressor models, etc.) to predict or output performance variables of the emissions of the ALS 100.

For example, the objective function may express emissions associated with the well sites 28 over a future time horizon subject to one or more constraints. The emission consumption objective function can have the form:

$$U ( x ) = {\sum }_{k = 1}^{m} {( Component Resource Usage )}_{k}$$

where k is a time step in an optimization period or time horizon, m is a total number of timesteps in the optimization period or time horizon, and x is a set of decision or controllable variables for the optimization.

In some embodiments, the optimization has the form:

minimize CE(x)

so that the optimizer 1126 is configured to determine values for the decision or control variables x that minimize the Emissions CE over the optimization period or the time horizon.

In some embodiments, the decision variables x are or include flow rates or pressures across the ALS 100, or across the well sites 28. For example, an nth pump (e.g., the pump of ESP 120, the pump of PCP 150, etc.) may have a function or model:

$$C {E}_{pump , n} = {f}_{p u m p , n} ( x )$$

where CE_{pump,n} is an estimated amount of the emissions that are produced by operations associated with the nth pump in order for the nth pump to achieve the x control decision (e.g., a flowrate Q, a pressure differential Δp, etc.) over a time step or instantaneously, and ƒ_{pump,n} is a function for the nth pump that predicts emissions associated with the pump as a function of the control or decision variable. As another example, an nth compressor (e.g., the compressor of GL 130, etc.) may have a function or model:

$$C {E}_{c o m p ressor , n} = {f}_{c o m p ressor , n} ( x )$$

where CE_{compressor,n} is an estimated amount of the emissions that are produced by operations associated the nth compressor in order for the nth compressor to achieve the x control decision (e.g., a flowrate Q, a pressure differential Δp, etc.) over a time step or instantaneously, and ƒ_{compressor,n} is a function for the nth compressor that predicts emissions as a function of the control or decision variable.

In some embodiments, the emission objective function is minimized subject to one or more constraints. In some embodiments, the constraints include limits on the pressurization of each of the pumps, runtime of the pumps, limits on an amount of chemical injection that can be introduced to the product based on the type of product currently produced by the well sites 28, inter-relationships between pumps of the well sites 28, the pressurization of each compressor, the runtime of the compressors, etc. In some embodiments the constraints are limits (e.g., upper and lower limits) of any of the decision or control variables x. In some embodiments, the constraints are inter-relationships between different of the control or decision variable x. For example, adjusting one of the control decisions may affect a limit of another of the control decisions. In some embodiments, the constraints include a minimal amount of product produced by the well sites 28 (e.g., find optimal control decisions that minimize emissions but still produce a particular amount of product, etc.). In some embodiments, the constraints include a maximum flow rate of a pump (e.g., find optimal control decisions that minimize emissions but do not reduce the reliability of the pump, etc.).

In some embodiments, optimization of the emission objective function as generated or defined by the emission objective function generator 1122 results in determining an optimal or minimal resource cost solution. For example, minimization of the emission of the emission objective function generator 1122 may result in minimal use of the equipment, and thereby reduced resource cost (e.g., fuel, electricity, etc.) being consumed by the equipment.

In some embodiments, the objective function generator 1118 is configured to use the system information to construct the objective functions, and to use the real-time sensor data to populate one or more terms or variables of the objective function. For example, the real-time sensor data can be used to inform the objective function generator 1118 regarding current conditions of the well sites 28, current operational status of equipment of the well sites 28, weather conditions at the well sites 28, etc.

Referring still to FIG. 7, the objective function generator 1118 includes the resource objective function generator 1120, according to some embodiments. In some embodiments, the resource objective function generator 1120 is configured to generate a resource objective function that determines amounts (e.g., volumes, weights, etc.) of the resources consumed by the well sites 28 as a function of one or more control decisions (e.g., operation of pumps) subject to one or more constraints. For example, the resource objective function generator 1120 may be configured to generate a resource objective function that determines an amount of a resource that is consumed as a function of one or more control decisions for controllable elements associated with the operation of the ALS 100. In some embodiments, the resource objective function generator 1120 utilizes system 500 to determine the objective function that quantitatively predicts or estimates the resource cost of the well sites 28 as a function of one or more control decisions based on sensor data and the inputs and outputs of system 500 described in more detail above.

For example, the objective function may express resource usage of the well sites 28 over a future time horizon subject to one or more constraints. The resource usage objective function can have the form:

$$U ( x ) = {\sum }_{k = 1}^{m} {( Component Resource Usage )}_{k}$$

where k is a time step in an optimization period or time horizon, m is a total number of timesteps in the optimization period or time horizon, and x is a set of decision or controllable variables for the optimization.

In some embodiments, the resource objective function is minimized by the optimizer 1126 subject to one or more constraints. The constraints for optimizing or minimizing the resource objective function can be the same as or similar to the constraints for optimizing or minimizing the emission objective function as described in greater detail above. In this way, the controller 1102 can determine optimal control decisions for the well sites 28 or for the ALS 100 of the well sites 28 in terms of resource usage for a future time horizon (e.g., a day, a week, several days, etc.).

Referring still to FIG. 7, the objective function generator 1118 includes the production objective function generator 1124, according to some embodiments. In some embodiments, the production objective function generator 1124 is configured to generate an objective function that determines a produced amount of product by the well site 28. For example, the produced amount of product can be defined as a flowrate of the well sites 28, or a quantity of product (e.g., in gallons, liters, weight, etc.) of the product produced by the well sites 28 over a period of time. In some embodiments, the production objective function defines produced amount of product in terms of the control or decision variables x. In some embodiments, the production objective function is provided to the optimizer 1126 and maximized to determine control or decision variables that result in maximum product delivery. In some embodiments, the production objective function generator 1124 is configured to generate an objective functions that determines a produced amount of product associated with the operation of the ALS 100. In this way, the ALS 100 of the well sites 28 can be operated to deliver as much product as possible to the customer, regardless of the energy consumption, emissions, or costs associated with doing so.

The optimizer 1126 is configured to obtain any of the objective functions described herein from the objective function generator 1118 and optimize (e.g., maximize or minimize) the objective functions to determine control or decision variables that result in the desired behavior of the well sites 28. In some embodiments, the control or decision variables include determinations of how to run the ALS 100 (e.g., how to operate the pumps of the ESP 120, the chemical injection flow rate of the GL 130, etc.) to achieve minimal emissions and/or minimal resource usage, or maximize product production of the well sites 28 over a time period. In various embodiments, the optimizer 1126 is configured to combine the various objective functions in order to optimize the operation of the ALS 100. For example, the optimizer 1126 may combine the emission objective function and the production objective function associated with the ALS 100 in order to determine control decisions for controllable elements associated with the ALS 100 that result in emissions associated with the ALS 100 being less than an emission threshold while production associated with the ALS 100 is still above a production threshold.

The optimizer 1126 is configured to provide detailed optimization results to the user input manager 1130 for display on the user interface 1132 (e.g., so that the user can view how the well sites 28 is to be operated to achieve the desired goal, so that the user can view how the controllable elements associated with the ALS 100 can be operated to achieve the desired goal, etc.), and is configured to provide control decisions to the well sites 28 or equipment thereof to operate the well sites 28 according to the control or decision variables. In some embodiments, the well sites 28 uses the control decisions that are determined by performing the optimization to operate the well sites 28. Further, the optimization techniques described herein are mathematically based as opposed to a subject matter expert (SME) approach.

### Discrete Optimizations

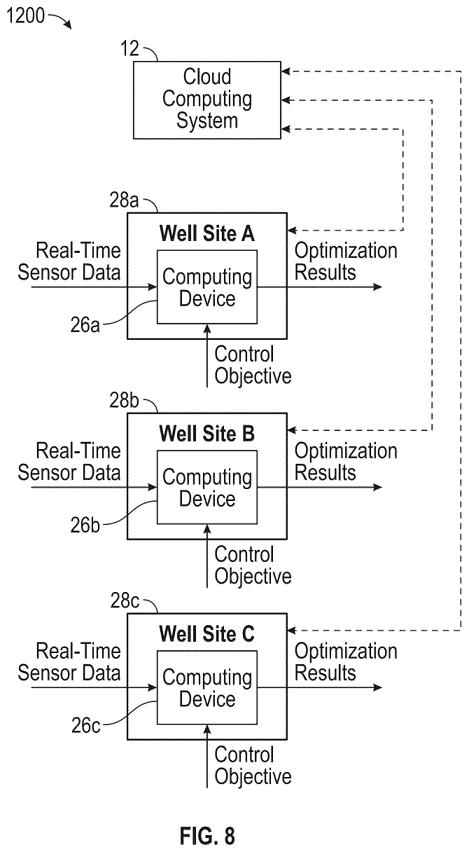

Referring particularly to FIG. 8, a block diagram 1200 of a discrete optimization system for multiple of the well sites 28a-28c is shown, according to some embodiments. In some embodiments, each of the well sites 28a-28c includes a RTU 46. In some embodiments, the first of the well sites 28a is configured to use the RTU 46a to perform an optimization for itself using real-time sensor data and/or a user input indicating a desired optimization mode by following the steps of the process 1300, discussed in greater detail herein. Similarly, the second of the well sites 28b and the third of the well sites 28c can use corresponding RTUs 46b and 46c to perform optimizations for themselves based on real-time sensor data and user inputs indicating desired optimization modes. In this way, the optimizations can be performed locally at each of multiple of the well sites 28a-28c to determine optimization results and/or control decisions for the equipment of multiple of the well sites 28a-28c. In some embodiments, the optimizations are performed autonomously at each of multiple of the well sites 28a-28c to facilitate autonomous optimal operation of each of multiple of the well sites 28a-28c. In some embodiments, each of the well sites 28 includes the ALS 100 and the discrete optimization system for multiple of the well sites 28 is used to optimize the operation of the ALS 100. In other embodiments, the discrete optimization system for multiple of the well sites 28 may include a different number of the well sites 28 (e.g., two, four, five, etc.). In some embodiments, process 1000 is performed to determine the carbon emission data and/or the resource usage data associated with each of the well sites 28a-28c, a control objective for the well sites 28a-28c, and a control decision for at least one of the well sites 28a-28c based on the carbon emission data and/or the resource usage data that achieves the control object.

In some embodiments, the cloud-based computing system 12 is configured to obtain data from any of multiple of the well sites 28a-28c to perform an overall optimization for multiple of the well sites 28a-28c in a coordinated manner. In some embodiments, the cloud-based computing system 12 is configured to use any of the functionality of the RTU 46 to perform an overall optimization of multiple of the well sites 28a-28c. In this way, the optimization techniques as described in greater detail above with reference to FIG. 7 can be implemented locally at each well sites 28a-28c to optimize operation of each well sites 28a-28c or can be implemented on the cloud-based computing system 12 globally for multiple of the well sites 28a-28c to determine an optimal operation of multiple of the well sites 28a-28c. In some embodiments, an overall optimization of multiple of the well sites 28a-28c is performed in a distributed manner among the RTUs 46a-46c of the well sites 28a-28c, with the RTUs 46a-46c in communication with each other. In some embodiments, an overall optimization is performed (either at cloud-based computing system 12 or distributed among RTUs 46a-46c) and if communications disruptions are detected, the RTUs 46a-46c default to performing individual optimizations for each of the well sites 28a-28c.

### High Level Optimization Processes

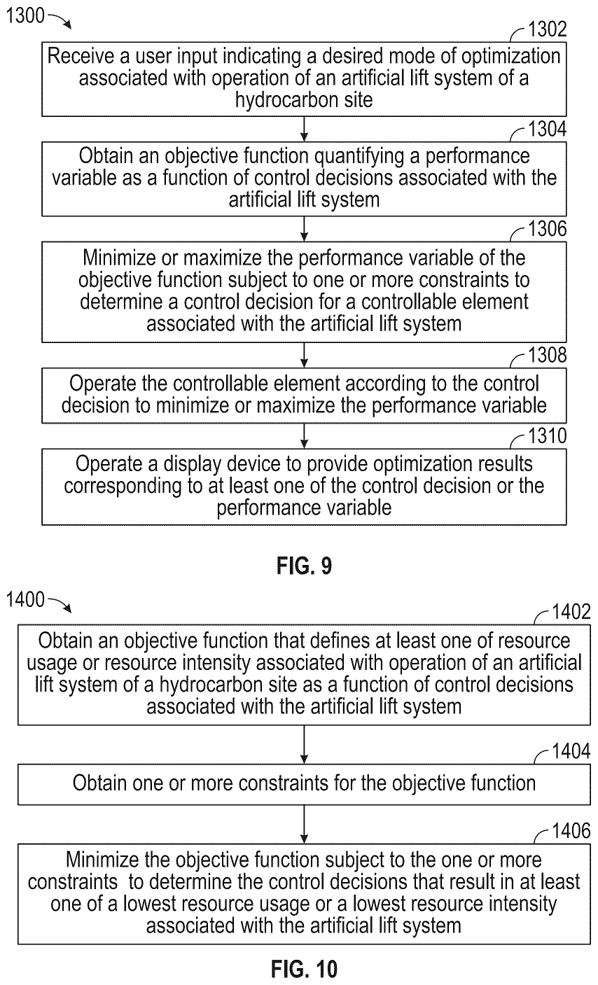

Referring particularly to FIG. 9, a process 1300 for optimizing operation of an artificial lift system of a hydrocarbon site is shown, according to some embodiments. Process 1300 includes steps 1302-1310 and can be performed by the computing device 26, the computing devices 26a-26c, or the cloud-based computing system 12 as described in greater detail above.

Process 1300 includes receiving a user input indicating a desired mode of optimization associated with operation of an artificial lift system of a hydrocarbon system, (step 1302), according to some embodiments. Step 1302 may include a user input indicating desired modes of optimization and operation of an artificial lift system of a single well site or artificial lift systems of multiple well sites. In some embodiments, step 1302 includes receiving an input indicating whether the process 1300 should be performed to optimize and operate according to at least one of resource usage of the well sites 28, resource intensity of the well sites 28, emissions associated with the well sites 28, emission intensity associated with the well sites 28, and/or production rate of the well sites 28. In some embodiments, the desired mode of optimization and operation of the well sites 28 is automatically determined based on user inputs. In various embodiments, the step 1302 includes receiving an input indicating whether the process 1300 should be performed to optimize and operate according to at least one of resource usage of multiple of the well sites 28, resource intensity of multiple of the well sites 28, emissions associated with multiple of the well sites 28, emission intensity associated with multiple of the well sites 28, and/or production rate of multiple of the well sites 28.

Process 1300 includes obtaining an objective function quantifying a performance variable as a function of control decisions associated with the artificial lift system (step 1304), according to some embodiments. In some embodiments, the objective function determines the performance variable as a function of the control decisions associated with the ALS 100 over a future time period. In some embodiments, the performance variable is any of production rate, resource usage, resource intensity, emissions, and/or emission intensity. In some embodiments, step 1304 is performed by utilizing the system 400 to determine the emissions and/or emission intensity associated with the ALS 100 and/or system 500 to determine the resource usage and/or resource usage intensity associated with the ALS 100. In some embodiments, the objective function that quantifies the performance variable is a function of control decisions of the ALS 100 of the well sites 28 (e.g., decision to increase or decrease flow rate of the ESP 120 of ALS 100, decision to increase or decrease the gas provided to the GL 130, etc.). In various embodiments, the objective function predicts the performance variable as a function of the control decisions of multiple of the well sites 28 over a future time period.

Process 1300 includes minimizing or maximizing the performance variable of the objective function subject to one or more constraints to determine a control decision for a controllable element associated with the artificial lift system (step 1306), according to some embodiments. In some embodiments, step 1306 includes minimizing or maximizing the performance variables of objective functions associated with artificial lift systems of multiple well sites to determine control decisions for controllable elements associated with each of the artificial lift systems. In some embodiments, step 1306 includes minimizing or maximizing the performance variable by varying or adjusting values of the control decisions over a future time period. In some embodiments, the constraints include limits on different control decisions, internal parameters, parameters of the pumps (e.g., max operational flow rate, etc.), etc. In various embodiments, the constraints include limits on control decisions over the future time period (e.g., restricting the parameters of the pumps over the future time period to increase the reliability of the pumps, etc.). In some embodiments, step 1306 is performed to determine control decisions that result in minimum or maximum of the performance variable over the future time period. In various embodiments, step 1306 includes varying or adjusting values of the control decisions of multiple of the well sites 28 over a future time period.

Process 1300 includes operating the controllable element according to the control decisions to minimize or maximize the performance variable (step 1308), according to some embodiments. In some embodiments, step 1308 includes adjusting various control parameters of different equipment associated with the ALS 100 of the well sites 28 according to the control decisions. In some embodiments, step 1308 includes providing the control decisions to different equipment of the well site 28. In some embodiments, step 1308 includes operating the equipment of the well sites 28 over the future time period according to the control decisions. The control decisions can be a schedule of different pump setpoints, operational parameters, the quantity of chemicals to inject, when and where to inject the chemicals, etc. In some embodiments, step 1308 includes adjusting various control parameters associated with the ALS 100 of the well sites 28 according to the control decisions. In various embodiments, step 1308 includes adjusting various control parameters of multiple of the well sites 28 according to the control decisions. In some embodiments, step 1308 is automatically performed. In other embodiments, step 1308 is manually performed. In still other embodiments, the process 1300 does not include the step 1308. By way of example, the process 1300 may not include step 1308 when the process 1300 is configured to display at least one of the control decision or the performance variable to an operator so that the operator can analyze the control decision and determine (e.g., manually determine, etc.) how to operate the ALS 100.

Process 1300 includes operating a display device to provide optimization results corresponding to at least one of the control decision or the performance variables (step 1310), according to some embodiments. In some embodiments, step 1310 includes operating the display device to provide display data of the optimization results. In some embodiments, the display device is any of the computing devices 26 (FIG. 1). In some embodiments, the display device is configured to access the display data via a server or a webpage.

Referring particularly to FIG. 10, a process 1400 for optimizing operation of an artificial lift system of a hydrocarbon site is shown, according to some embodiments. Process 1400 includes steps 1402-1406 and be performed by the objective function generator 1118 and the optimizer 1126 as described in greater detail above with reference to FIG. 7. In some embodiments, process 1400 is performed to determined how to operate the well sites 28 in a manner that uses the least amount of resources. In some embodiments, process 1400 is performed with respect to the resource usage of a single resource (e.g., electricity usage, chemical usage, etc.). In other embodiments, process 1400 is performed with respect to the resource usage of multiple resources to determine the resource usage of each of the resources. In various embodiments, process 1400 is performed to determine how to operate multiple of the well sites 28 in a manner that uses the least amount of resources across multiple of the well sites 28. In some embodiments, process 1400 is performed as steps 1304-1306 of process 1300.

Process 1400 includes obtaining an objective function that defines at least one of resource usage and/or resource intensity associated with operation of an artificial lift system of a hydrocarbon site as a function of control decisions associated with the artificial lift system (step 1402), according to some embodiments. In some embodiments, step 1402 includes defining an objective function that expresses resource usage associated with operation of the ALS 100 of the well sites 28 summed over a future time horizon or the resource intensity associated with operation of the ALS 100 of the well sites 28 averaged over the future time horizon. The resource usage of operation or the resource intensity can be determined utilizing the system 500 described in more detail above. In some embodiments, the resource usage of operation or the resource intensity may focus on a particular resource (e.g., electricity, liquid fuel, chemicals, etc.). In some embodiments, the resource intensity is a resource usage per a unit of production that is determined based on an amount of the resource usage over the future time horizon. In some embodiments, the resource intensity may focus on a particular resource (e.g., electricity usage per unit of production, chemical usage per unit of production, etc.). In some embodiments, the objective function that quantifies the resource usage of operation of the well sites 28 summed over a future time horizon or the resource intensity of the well sites 28 averaged over the future time horizon is a function of control decisions of the ALS 100 of the well sites 28 (e.g., decision to increase or decrease flow rate of the ESP 120 of ALS 100, decision to increase or decrease the gas provided to the GL 130, etc.). In various embodiments, step 1402 includes defining an objective function that expresses resource usage of operation of multiple of the well sites 28 summed over a future time horizon or the resource intensity of multiple of the well sites 28 averaged over the future time horizon.

Process 1400 includes obtaining one or more constraints for the objective function (step 1404), according to some embodiments. In some embodiments, step 1404 includes defining, generating, or otherwise obtaining the one or more constraints for the objective function. In some embodiments, the constraints include limits on operability of the various equipment of the well sites 28, limits on the amount of chemicals that can be provided to different types of products being produced by the well sites 28, etc. In some embodiments, the constraints include limits intended to increase the reliability of the various equipment of the well sites 28 (e.g., decreasing the flow rate through the ALS 100 to increase the lift of the ALS 100, etc.). In some embodiments, the constraints are additional equations or conditions that must be met in order for the solution to be viable or realistically achievable. In some embodiments, step 1404 is performed by the objective function generator 1118 or the optimizer 1126.

Process 1400 includes minimizing the objective function subject to the one or more constraints to determine the control decisions that result in at least one of a lowest resource usage or a lowest resource intensity associated with the artificial lift system (step 1406), according to some embodiments. In some embodiments, step 1406 includes performing a multi-variable optimization to determine control decisions that satisfy the one or more constraints and that result in a lowest or optimal resource usage associated with operation of the ALS 100 of the well sites 28. In other embodiments, step 1406 includes performing a multi-variable optimization to determine control decisions that satisfy the one or more constraints and that result in a lowest or optimal resource intensity associated with operation of the ALS 100. In some embodiments, the multi-variable optimization determines control decisions for the ALS 100 of the well sites 28 that satisfy the one or more constraints. In some embodiments, step 1406 is performed by the optimizer 1126 based on the objective function obtained in step 1404. In various embodiments, step 1406 includes performing a multi-variable optimization to determine control decisions that satisfy the one or more constraints and that result in a lowest or optimal resource usage and/or the lowest or optimal resource intensity of operation of multiple of the well sites 28.

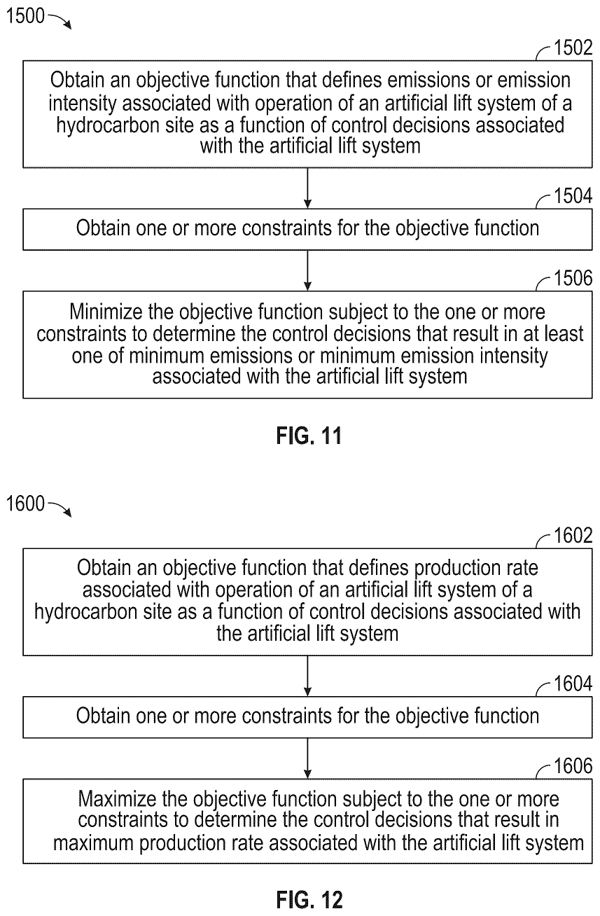

Referring particularly to FIG. 11, a process 1500 for performing an optimization of operation of an artificial lift system in terms of emissions and/or emission intensity is shown, according to some embodiments. Process 1500 includes steps 1502-1506 and can be performed by the objective function generator 1118 and the optimizer 1126 as described in greater detail above with reference to FIG. 7. In some embodiments, process 1500 is performed to determine how to operate the well sites 28 in a manner that produces the least amount of emissions or the lowest emission intensity. In various embodiments, process 1500 is performed to determine how to operate multiple of the well sites 28 in a manner that produces the smallest emissions or the least emission intensity across multiple of the well sites 28. In some embodiments, process 1500 is performed as steps 1304-1306 of process 1300.

Process 1500 includes obtaining an objective function that defines emissions and/or emission intensity associated with operation of an artificial lift system of a hydrocarbon site as a function of control decisions associated with the artificial lift system (step 1502), according to some embodiments. In some embodiments, step 1502 includes defining an objective function that expresses emissions and/or emission intensity of the well sites 28 summed over a future time horizon. The emissions and/or emission intensity can be determined utilizing the system 400 described in more detail above. The emissions can include emissions associated various pumps, equipment, separators, compressors, etc. associated with the artificial lift system as a function of one or more of the control decisions. In some embodiments, the objective function that quantifies the emissions of the well sites 28 summed over a future time horizon and/or the emission intensity of the well sites 28 averaged over the future time horizon is a function of control decisions of the ALS 100 of the well sites 28 (e.g., decision to increase or decrease flow rate of the ESP 120 of ALS 100, decision to increase or decrease the gas provided to the GL 130, etc.). In some embodiments, the control decisions are adjustments to various controllable equipment associated with the ALS 100 of the well sites 28 that affects the emissions and/or emission intensity associated with the ALS 100 of the well sites 28. In various embodiments, step 1502 includes defining an objective function that expresses the emissions associated with the ALS 100 of multiple of the well sites 28 summed over a future time horizon and/or the emission intensity associated with the ALS 100 of multiple of the well sites 28 averaged over the future time horizon.

Process 1500 includes obtaining one or more constraints for the objective function (step 1504), according to some embodiments. In some embodiments, step 1504 is the same as or similar to step 1404 of process 1400. In some embodiments, the constraints include limits intended to increase the reliability of the various equipment associated with the ALS 100 of the well sites 28. In some embodiments, step 1504 includes defining one or more constraints that limit various parameters (e.g., control decisions, the performance variable, operational parameters of multiple of the well sites 28, etc.). In some embodiments, step 1504 is performed by the objective function generator 1118 or the optimizer 1126.

Process 1500 includes minimizing the objective function subject to the one or more constraints to determine the control decisions that result in at least one of lowest emissions or lowest emission intensity associated with the artificial lift system (step 1506), according to some embodiments. In some embodiments, step 1506 is the same as or similar to step 1406 of process 1400.

Referring particularly to FIG. 12, a process 1600 for optimizing operation of an artificial lift system of a hydrocarbon site in terms of production is shown, according to some embodiments. Process 1600 includes steps 1602-1606 and can be performed by the objective function generator 1118 and the optimizer 1126 as described in greater detail above with reference to FIG. 7. In some embodiments, process 1600 is performed to determine how to operate the well sites 28 to provide as much product from the well sites 28, regardless of the emissions and/or resource usage associated with such operation. In other embodiments, the process 1600 is performed as part of process 1400 or process 1500 to optimize the resource usage intensity and/or the emission intensity (e.g., by increasing the production of the well sites 28 at a higher rate than the resource usage and/or the emissions, etc.). In some embodiments, the production is defined in terms of volume, rate, etc., of the product from the well sites 28. In various embodiments, process 1600 is performed to determine how to operate multiple of the well sites 28.

Process 1600 includes obtaining an objective function that defines production rate associated with operation of an artificial lift system of a hydrocarbon site as a function of control decisions associated with the artificial lift system (step 1602), according to some embodiments. In some embodiments, step 1602 includes defining an objective function that quantitatively predicts quantity of produced product or flow rate of produced product associated with the ALS 100 of the well sites 28 as a function of one or more control decisions. In some embodiments, step 1602 is the same as or similar to step 1402 or step 1502 of process 1400 or 1500, respectively. In some embodiments, step 1602 includes defining an objecting function that quantitatively predicts quantity of produced product or flow rate of produced product of the well sites 28 as a function of one or more control decisions of the ALS 100 of the well sites 28. In various embodiments, step 1602 includes defining an objective function that quantitatively predicts quantity of produced product or flow rate of produced product of multiple of the well sites 28 as a function of one or more control decisions.

Process 1600 includes obtaining one or more constraints for the objective function (step 1604), according to some embodiments. In some embodiments, step 1604 is the same as or similar to step 1404 of process 1400 or the same as or similar to step 1504 of process 1500. Process 1600 includes maximizing the objective function subject to the one or more constraints to determine the control decisions that result in a highest production rate associated with the artificial lift system (step 1606), according to some embodiments. In some embodiments, step 1606 is performed to maximize the production associated with the ALS 100 of the well sites 28, regardless of emissions and/or resource usage associated with such operation. In various embodiments, step 1606 is performed to maximize the production of multiple of the well sites 28, regardless of emissions and/or resource usage associated with such operation. Process 1600 can be performed as steps 1304-1306 of process 1300.

### Configuration of Exemplary Embodiments

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of various systems and methods as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A method for managing a well site, the method comprising:
acquiring, from a sensing unit associated with the well site, sensor data associated with operation of the well site;
determining, based on the sensor data, at least one of emission data corresponding to emissions associated with the well site or resource usage data corresponding to resource usage associated with the well site;
generating display data corresponding to the at least one of the emission data or the resource usage data; and
operating a display device to provide the display data to a user.

2. The method of claim 1, further comprising:
receiving, from the display device, a user input indicating a control objective of the well site;
determining, based on the sensor data and the at least one of the emission data or the resource usage data, a control decision for a controllable element of the well site that achieves the control objective; and
operating the display device to provide the control decision to the user.

3. The method of claim 2, further comprising:
operating the control element according to the control decision to achieve the control objective.

4. The method of claim 2, wherein the control decision is determined following the steps of:
obtaining an objective function that defines at least one of the emissions associated with the well site or the resource usage associated with the well site as a function of control decisions for controllable elements of the well site; and
minimizing the objective function to determine the control decision that results in at least one of a minimum emissions or a minimum resource usage associated with the well site.

5. The method of claim 1, further comprising:
determining, based on the sensor data, at least one of emission intensity data corresponding to an emission intensity associated with the well site or resource usage intensity data corresponding to a resource usage intensity associated with the well site;
generating intensity display data corresponding to the at least one of the emission intensity data or the resource usage intensity data; and
operating the display device to provide the intensity display data to the user.

6. The method of claim 1, wherein:
the well site includes an artificial lift system; and
the at least one of the emission data or the resource usage data includes a portion associated with operation of the artificial lift system.

7. The method of claim 6, further comprising:
receiving, from the display device, a user input indicating a control objective of the well site;
determining, based on the sensor data and the portion of the at least one of the emission data or the resource usage data associated with operation of the artificial lift system, a control decision for a controllable element associated with the artificial lift system that achieves the control objective; and
operating the display device to provide the control decision to the user.

8. The method of claim 1, wherein the display device is operated to provide a live dashboard associated with the display data, the live dashboard indicating at least one of live emissions associated with the well site or live resource usage associated with the well site.

9. The method of claim 1, wherein the display data includes a first portion of the at least one of the emission data or the resource usage data associated with a first well device of the well site and a second portion of the at least one of the emission data or the resource usage data associated with a second well device of the well site.

10. The method of claim 1, further comprising:
forecasting, based on the at least one of the emission data or the resource usage data, at least one of the emissions associated with the well site the resource usage associated with the well site;
determining, based on the forecast, a control decision for a controllable element of the well site; and
operating the controllable element according to the control decision such that the at least one of the emissions or the resource usage does not exceed a threshold.

11. The method of claim 1, wherein the method includes determining both the emission data and the resource usage data.

12. A computing system configured to monitor and/or control one or more operations of a hydrocarbon site, the computing system comprising:
a processor configured to:
acquire, from a sensing unit associated with the hydrocarbon site, sensor data associated with operation of the hydrocarbon site;
determine, based on the sensor data, at least one of emission data corresponding to emissions associated with the hydrocarbon site or resource usage data corresponding to resource usage associated with the hydrocarbon site;
determine, based on the sensor data, a portion of the of the at least one of the emission data or the resource usage data associated with operation of an artificial lift system of the hydrocarbon site;
generate display data corresponding to the portion of the at least one of the emission data or the resource usage data; and
operate a display device to provide the display data to a user.

13. The computing system of claim 12, wherein the processor is further configured to:
receive, from the display device, a user input indicating a control objective of the artificial lift system;
determine, based on the sensor data and the portion of the of the at least one of the emission data or the resource usage data, a control decision for a controllable element associated with the artificial lift system that achieves the control objective; and
operate the display device to provide the control decision to the user.

14. The computing system of claim 13, wherein the processor is further configured to:
operate the control element according to the control decision to achieve the control objective.

15. The computing system of claim 13, wherein the control decision is determined following the steps of:
obtaining an objective function that defines at least one of the emissions associated with the artificial lift system or the resource usage associated with the artificial lift system as a function of control decisions for controllable elements of the artificial lift system; and
minimizing the objective function to determine the control decision that results in at least one of a minimum emissions or a minimum resource usage associated with the artificial lift system.

16. The computing system of claim 12, wherein the display device is operated to provide a live dashboard associated with the display data, the live dashboard indicating at least one of live emissions associated with the artificial lift system or live resource usage associated with the artificial lift system.

17. A hydrocarbon system comprising:
a first site device;
a second site device; and
a processor configured to:
acquire, from a sensing unit associated with the hydrocarbon system, sensor data associated with operation of the first site device and the second site device;
determine, based on the sensor data, at least one of (i) first emission data associated with operation of the first site device and second emission data associated with the second site device or (ii) first resource usage data associated with the operation of the first site device and second resource usage data associated with the operation of the second site device;
generate display data corresponding to the at least one of (i) the first emission data and the second emission data or (ii) the first resource usage data and the second resource usage data; and
operate a display device to provide the display data to a user.

18. The hydrocarbon system of claim 17, wherein the processor is further configured to:
receive, from the display device, a user input indicating a control objective of the hydrocarbon system;
determine, based on the sensor data and the at least one of (i) the first emission data and the second emission data or (ii) the first resource usage data and the second resource usage data, a first control decision for a first controllable element associated with the first site device that achieves the control objective; and
operate the display device to provide the control decision to the user.

19. The hydrocarbon system of claim 18, wherein the first control decision is determined following the steps of:
obtaining an objective function that defines at least one of (i) the first emission data and the second emission data or (ii) the first resource usage data and the second resource usage data as a function of a first control decision for the first controllable element associated with the first site device and a second control decision for a second controllable element associated with the second site device; and
minimizing the objective function to determine that the first control decision results in a lower of at least one of emissions or resource usage of the hydrocarbon system than the second control decision.

20. The hydrocarbon system of claim 17, wherein the display device is operated to provide a live dashboard associated with the display data, the live dashboard indicating at least one of (i) live emissions associated with the first site device and the second site device or (ii) live resource usage associated with the first site device and the second site device.
